(19) United States
(12) Patent Application Publication
(10) Pub. No.: US 2026/0176552 A1
(43) Pub. Date: Jun. 25, 2026

(54) METHOD OF LAUNDERING FABRIC

(71) Applicant: THE PROCTER & GAMBLE COMPANY, Cincinnati, OH (US)

(72) Inventors: Rachel Morgan Clayton ROEDER, Miamisburg, OH (US); Patrick Christopher STENGER, Fairfield, OH (US); Laura ORLANDINI, Le Mont-sur-Lausanne (CH); Brian Joseph LOUGHNANE, Sharonville, OH (US); Marc Johan DECLERCQ, Grimbergen (BE); Michael Joseph MEESE, JR., Cincinnati, OH (US)

(21) Appl. No.: 19/421,260

(22) Filed: Dec. 16, 2025

Related U.S. Application Data
(60) Provisional application No. 63/737,097, filed on Dec. 20, 2024.

(51) Int. Cl. C11D 1/14; C11D 1/83; C11D 3/30; C11D 3/50; C11D 17/00; C11D 17/06

(52) U.S. Cl. CPC C11D 1/146; C11D 1/143; C11D 1/83; C11D 3/30; C11D 3/505; C11D 17/0008; C11D 17/06

(57) ABSTRACT

The present invention relates to a method of laundering fabric, the method comprising the steps of washing a fabric in at least one wash step, wherein in the at least one wash step, the fabric is washed with a detergent composition that comprises i. from about 1% to about 30%, by weight of the composition of a branched alkyl sulfate anionic surfactant consisting essentially of a mixture of surfactant isomers of Formula 1 and surfactants of Formula 2:

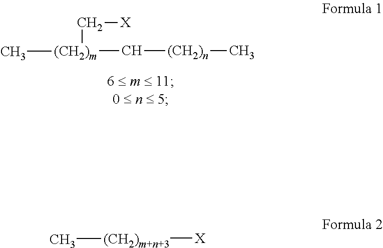

wherein from about 50% to about 100% by weight of the branched alkyl sulfate anionic surfactant are isomers having m+n=11; wherein between about 25% to about 50% of the mixture of surfactant isomers of Formula 1 have n=0; wherein from about 0.001% to about 25% by weight of the branched alkyl sulfate anionic surfactant are surfactants of Formula 2; and wherein X is a hydrophilic moiety; and subsequently softening the fabric in at least one treatment step, wherein in the at least one treatment step, the fabric is treated with a fabric conditioning composition comprising alkyl quaternary ammonium ester material.

### FIELD OF THE INVENTION

Regimens and methods of laundering fabric that include washing with a detergent composition and treating with a fabric conditioning composition.

### BACKGROUND OF THE INVENTION

Some surfactants employed in detergent compositions are known to carry-over from the wash step into the rinse step of a laundering process and subsequently hinder the performance of a fabric conditioning composition used in the rinse step. In addition, in laundering methods where fabric conditioning compositions are added to the wash cycle in forms such as softening beads, some surfactants employed in detergent compositions are known to interact with the fabric conditioning compositions and hinder their fabric softening performance. Specifically, it is known that detergent compositions that contain high levels of present/carry-over anionic surfactant tend to decrease overall softener deposition and efficacy on fabrics, therefore decreasing the softness benefit sought by using fabric conditioner compositions in the rinse cycle. However, despite the above-mentioned drawbacks, anionic surfactants are still widely used in fabric care detergent compositions due to their effectiveness in cleaning. Accordingly, it is of continued interest to create laundering processes that are both highly effective in cleaning and conditioning (e.g., softening) fabrics in a single process with one or more steps.

### SUMMARY OF THE INVENTION

The present disclosure relates to a method of laundering fabric, the method comprising the steps of washing a fabric in at least one wash step, wherein in the at least one wash step, the fabric is washed with a detergent composition that comprises i. from about 1% to about 30%, by weight of the composition of a branched alkyl sulfate anionic surfactant consisting essentially of a mixture of surfactant isomers of Formula 1 and surfactants of Formula 2:

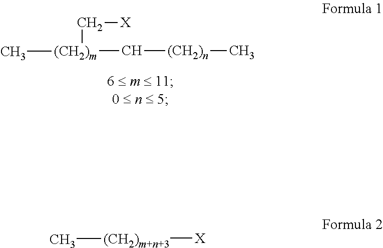

wherein from about 50% to about 100% by weight of the branched alkyl sulfate anionic surfactant are isomers having m+n=11; wherein between about 25% to about 50% of the mixture of surfactant isomers of Formula 1 have n=0; wherein from about 0.001% to about 25% by weight of the branched alkyl sulfate anionic surfactant are surfactants of Formula 2; and wherein X is a hydrophilic moiety; and softening the fabric in at least one treatment step, wherein in the at least one treatment step, the fabric is softened with a fabric conditioning composition comprising alkyl quaternary ammonium ester material.

The present disclosure further relates to a method of providing improved softness to a fabric, the method comprising the steps of: treating a fabric in a rinse liquor that comprises water, alkyl quaternary ammonium ester material, and a branched alkyl sulfate anionic surfactant that is a mixture of surfactant isomers of Formula 1 and surfactants of Formula 2:

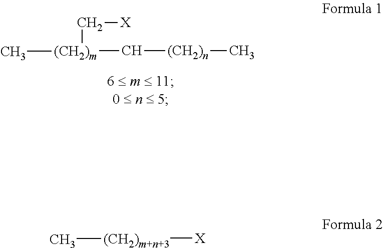

wherein X is a hydrophilic moiety.

The present disclosure further relates to a method of laundering fabric in an automated washing machine, the method comprising the steps of: placing a fabric in a drum of the automated washing machine, dispensing water and a detergent composition into the drum to create a wash liquor, wherein the fabric in washed in the wash liquor in at least one wash step, the detergent composition comprising: from about 1% to about 30%, by weight of the composition of a branched alkyl sulfate anionic surfactant consisting essentially of a mixture of surfactant isomers of Formula 1 and surfactants of Formula 2:

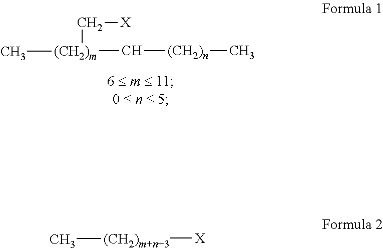

wherein from about 50% to about 100% by weight of the branched alkyl sulfate anionic surfactant are isomers having m+n=11; wherein between about 25% to about 50% of the mixture of surfactant isomers of Formula 1 have n=0; wherein from about 0.001% to about 25% by weight of the branched alkyl sulfate anionic surfactant are surfactants of Formula 2; and wherein X is a hydrophilic moiety; and draining the wash liquor from the drum; and dispensing water and a fabric conditioning composition into the drum to create a treatment liquor, wherein the fabric is softened in at least one treatment step, the fabric conditioning composition comprising an alkyl quaternary ammonium ester material.

### DETAILED DESCRIPTION OF THE INVENTION

The laundry methods described herein utilize detergent compositions to clean effectively in a wash step while also improving the softness benefit brought about by use of fabric conditioning compounds in a treatment step.

In a single laundering process, it has been found that treating fabrics with the particular fabric conditioning compositions detailed herein can improve the softness of the fabrics, preferably fabrics comprising cotton and polycotton, after the fabrics have been washed in a previous step with a detergent composition comprising the particular branched alkyl sulfate anionic surfactants detailed herein. Without being bound by theory, the carry-over of the particular branched alkyl sulfate anionic surfactants detailed herein on the fabric from the wash to the rinse interacts with the alkyl quaternary ammonium ester material such that not all the alkyl quaternary ammonium ester material is neutralized via coacervation (such coacervation is observed with use of other anionic surfactants). This enables improved softness feel on the fabric since less alkyl quaternary ammonium ester material is neutralized in a crystalline form, maintaining a flexible film on fabric-translating to a softer fabric feel.

### Method of Laundering Fabric:

The present invention relates to a method of laundering fabric. While the present disclosure is particularly directed towards domestic, that is, household, laundry methods, the invention is also relevant for larger scale, industrial laundry processes, including both continuous and discontinuous industrial laundry processes.

The present method is suitable for laundering fabric selected from the group consisting of: cotton, polycotton, polyester, other synthetic fibers such as those used in athletic wear and athletic leisure wear, and mixtures thereof; especially fabrics comprising cotton.

In a domestic laundering process, the first step typically involves sorting the laundry based on colour, fabric type, and level of dirtiness. This ensures that delicate fabrics are separated from heavier ones and that heavily soiled items are treated appropriately. Alternatively, the user may choose not to sort the fabrics to be washed, for instance. At least some of the fabrics can be treated before in laundering in a washing machine, for instance, through “spot treating” stains using a stain remover, bleach, or even detergent composition.

Once sorted, the laundry is loaded into the washing machine drum. The laundry detergent is then added at the appropriate level, which can be defined by the user, or in the case of “autodose” washing machines, the amount of detergent that is added can be determined by the washing machine itself after the washing machine is started, using sensors and algorithms provided within the washing machine.

The washing machine is started, and the laundry undergoes a series of steps, including optionally a prewash step, and at least one wash step which comprises adding the detergent composition and water to washing machine drum comprising the fabrics to be washed, soaking and agitating the fabrics.

The at least one wash step can have a duration of from 5 minutes to 60 minutes, preferably from 10 minutes to 40 minutes, more preferably from 15 minutes to 25 minutes.

Typically, the amount of water added during each wash step is from 5.0 litres to 100.0 litres, preferably from 7.0 litres to 40.0 litres, more preferably from 10.0 litres to 20.0 litres.

The wash liquor (i.e., the water with added laundry products in it, e.g., liquid or powder or granular or fibrous detergent compositions, and/or fabric conditioning compositions in liquid or softening bead or granule form, etc.) can have a surfactant concentration of greater than 100 ppm, preferably from 400 ppm to 2,500 ppm, more preferably from 600 ppm to 1000 ppm.

The fabric and wash liquor can be present in a weight ratio of from about 0.02 to about 0.6, preferably from about 0.03 to about 0.5, more preferably from about 0.1 to about 0.4.

Typically, the amount of detergent composition added during one or more wash step(s) can each, or in total, be from 15 ml to 200 ml, preferably from 20 ml to 100 ml, more preferably from 25 ml to 75 ml, for liquid detergent compositions, or from 10 g to 300 g, preferably from 20 g to 200 g litres, more preferably from 30 g to 150 g, for powder or granular detergent compositions.

Fabric conditioning compositions in the form of softening granules or softening beads may also be added during the one or more wash step. Softening granules or softening beads can be added alone or in combination with scent granules or scent beads. Typically, the amount of softening granules or softening beads added during one or more wash step(s) can each, or in total, be from 5 grams to 50 grams, preferably from 8 grams to 40 grams, more preferably from 10 to 30 grams.

As such, the surfactant of the detergent composition can be present in the wash liquor of the wash step at a level of from 50 ppm to 2000 ppm, preferably from 100 ppm to 1000 ppm, more preferably from 300 ppm to 800 ppm. In laundering methods that include the addition of fabric conditioning compositions in the washing step, the alkyl quaternary ammonium ester material of the fabric conditioning compounds can be present in the wash liquor of the wash step at a level of from 1 ppm to 3000 ppm, preferably from 4 ppm to 2000 ppm, more preferably from 7 ppm to 1000 ppm.

The detergent composition can be added directly into the washing machine drum. Alternatively, the detergent composition can be added into a detergent compartment, provided in the washing machine. In applications where here the detergent composition is added to a detergent compartment, at the start of the wash step, the detergent composition is dispensed into the washing machine drum by mixing with at least part of the water used to make the wash liquor. Such dispensing has the advantage of at least partially solubilising the detergent composition prior to addition to the washing machine drum. The solubilized detergent composition works to remove dirt, stains, and/or odors from the fabrics. Typically, the wash step ends with spin drying in order to remove a substantial part of the wash liquor (and dirt) from the fabric.

The present method of laundering fabrics can comprise one, or more than one, wash step. Preferably, the method comprises from one to three wash steps, preferably from one to two wash steps. The wash steps are typically consecutive.

The present invention can relate to low temperature methods of laundering, wherein the wash liquor is at a temperature of 40° C. or less, preferably from 10° C. to 30° C., more preferably from 15° C. to 25° C.

As mentioned earlier, the method can optionally comprise a pre-wash step. During the prewash step, the fabrics are soaked before the wash cycle step, in order to loosen up dirt and stains. Detergent composition is typically also added to during the prewash step. Alternatively, or in addition, a prewash additive or stain removal composition can be added to during the prewash step. Such prewash additives or stain removal compositions can comprise bleach, or bleach releasing compounds such as a percarbonate.

The last wash step is typically followed by one or more rinse steps (treatment step(s) if fabric conditioning composition is added to the fabric during the rinse step). The rinse step typically comprises the addition of water, followed by agitation, followed by spin-drying to remove a substantial part of the rinse water and entrained wash liquor. Typically, the amount of water added during each rinse step is from 5.0 litres to 100.0 litres, preferably from 7.0 litres to 40.0 litres, more preferably from 10.0 litres to 20.0 litres.

The water used during the at least one rinse step is typically unheated and hence is typically at the temperature of the domestic water supply. That is, typically from 10° C. to 15° C.

Typically, the amount of fabric conditioning composition added during each rinse step can be from 15 ml to 200 ml, preferably from 20 ml to 100 ml, more preferably from 25 ml to 75 ml, for liquid fabric conditioning compositions.

As such, the alkyl quaternary ammonium ester material of the fabric conditioning composition can be present in the rinse liquor of a treatment step at a level of from 1 ppm to 2000 ppm, preferably from 5 ppm to 950 ppm, more preferably from 7 ppm to 750 ppm. The surfactants from the detergent composition can also carry over and be present in the rinse liquor of a treatment step at a level of from about 5 ppm to about 200 ppm, preferably from about 10 ppm to about 100 ppm, more preferably from about 30 ppm to about 80 ppm.

As discussed above, the fabric conditioning composition can be added directly into the washing machine drum when in the form of softening bead or granule form. In such laundering processes where the fabric conditioning composition is added directed into the washing machine drum, the at least one wash step as detailed herein and the at least one rinse step as detailed herein can occur concurrently/simultaneously. Alternatively, the fabric conditioning composition can be added into a fabric softener compartment and then introduced into the washing machine drum at the end of, or after, the at least one wash step. Where the fabric conditioning composition is added to a fabric softener compartment, at the end of the at least one wash step or at the start of the at least one rinse step, the fabric conditioning composition is dispensed into the washing machine drum by mixing with at least part of the water used to make the rinse liquor. Such dispensing has the advantage of at least partially solubilising the fabric conditioning composition prior to addition to the washing machine drum. The solubilized fabric conditioning composition works to soften the fabrics. Typically, the rinse step ends with spin drying in order to remove a substantial part of the rinse liquor (and dirt) from the fabric.

Preferably, the laundering method comprises from one to three rinse steps, preferably from one to two rinse steps. The rinse steps are typically consecutive.

After the last rinse cycle, the fabrics are dried in a drying step. Depending on the available facilities and personal preference, the laundry can be air-dried on a clothesline or drying rack or placed in a dryer. If using a dryer, the appropriate settings, such as temperature and drying time, are selected to prevent damage to the fabrics. Further, if using a dryer, some laundering methods may include use of a fabric softening sheet or bar in the drying step. Accordingly, the alkyl quaternary ammonium ester material of the sheet or bar can be transferred to the fabric during this drying step. As with the wash and rinse steps detailed above, if fabric conditioning composition is applied to the fabric during the drying step, the drying step may also be considered a treatment step.

As further detailed herein, a treatment step can occur at any point that a fabric conditioning composition is applied to fabric during the laundering process. Thus, a treatment step may occur one or more times during an overall laundering process. Non-limiting examples of treatment steps may occur are when a fabric conditioning composition is added in the washing drum along with a detergent composition when the clothes are being agitated and washed (i.e., the washing step and the treatment step are happening concurrently), and/or when rinse water runs through the fabric softener drawer in the washing machine after the wash step, therefore applying fabric conditioning compound to the fabric (i.e., the rinse step and the treatment step are happening concurrently), and/or when the fabric is dried and a fabric conditioning compound is applied to the fabric by a sheet or bar in the dryer (i.e., the drying step and the treatment step are happening concurrently).

As detailed herein, when a wash step occurs, the fabric is washed with a detergent composition as detailed herein (e.g., employing the particular branched alkyl sulfate anionic surfactant detailed herein), and when the treatment step occurs, the fabric is softened with a fabric conditioning composition as detailed herein (e.g., employing the particular alkyl quaternary ammonium ester material detailed herein).

### Detergent Compositions

The detergent composition used in the methods detailed herein can be in any suitable form, such as liquid, paste, granular, solid, powder, or in conjunction with a carrier such as a substrate. Preferred detergent compositions are laundry detergent compositions that are either liquid or granular, with liquid being most preferred.

As used herein, “liquid detergent composition” refers to a liquid detergent composition which is fluid, and preferably capable of wetting and cleaning a fabric, e.g., clothing in a domestic washing machine. As used herein, “laundry detergent composition” refers to compositions suitable for washing clothes. The liquid detergent compositions can include solids or gases in suitably subdivided form, but the overall composition excludes product forms which are non-fluid overall, such as tablets or granules. The liquid laundry detergent composition preferably has a density in the range from 0.9 to 1.3 grams per cubic centimetre, more specifically from 1.00 to 1.10 grams per cubic centimetre, excluding any solid additives but including any bubbles, if present.

The composition can be an aqueous liquid laundry detergent composition. For such aqueous liquid laundry detergent compositions, the water content can be present at a level of from 5.0% to 95%, preferably from 25% to 90%, more preferably from 50% to 85% by weight of the liquid detergent composition.

The pH range of the detergent composition is from 6.0 to 8.9, preferably from pH 7 to 8.8.

The detergent composition can also be encapsulated in a water-soluble film, to form a unit dose article. A water-soluble unit dose article comprises at least one water-soluble film formed to create at least one internal compartment, wherein the at least one internal compartment comprises the liquid detergent composition. As such, the water-soluble film dissolves or disperses into a wash liquor comprising water. The water-soluble film is sealed such that the detergent composition does not leak out of the compartment during storage. Upon addition of the water-soluble unit dose article to water, the water-soluble film dissolves and releases the contents of the internal compartment into the wash liquor.

Liquid detergent compositions, contained within the unit dose article are low in water, comprising less than 20%, preferably from 5.0% to 20%, more preferably from 10% to 15% by weight of water. Such liquid detergent compositions are also typically highly concentrated, comprising ingredients, such as surfactants, at a level of 25% to 100%, preferably 30% to 70% higher than the active levels present in liquid detergent compositions which are not encapsulated into unit dose articles.

The unit dose article may comprise more than one compartment. The compartments may be arranged in superposed orientation, i.e. one positioned on top of the other. Alternatively, the compartments may be positioned in a side-by-side orientation, with the compartments separated by at least one seal. One compartment can at least partially surround a second compartment, or may completely enclose the second compartment. The unit dose article can comprise at least two compartments, one of the compartments being smaller than another compartment. The compartments can be the same or different volumes. The unit dose articles may have a weight of from 10 g to 40 g, or from 15 g to 35 g.

Prior to be being formed into a unit dose article, the water-soluble film can have a thickness of from 20 to 150 micron, or from 35 to 125 micron, or from 50 to 110 micron. Suitable water-soluble film materials typically comprise polymeric materials. The film material can be obtained by casting, blow-moulding, extrusion or blown extrusion of the polymeric material. The water-soluble film preferably comprises polyvinyl alcohol homopolymer, polyvinyl alcohol copolymer, or a blend of both. Suitable polyvinyl alcohol copolymers can be selected from sulphonated and carboxylated anionic polyvinylalcohol copolymers, especially carboxylated anionic polyvinylalcohol copolymers. A blend of polyvinylalcohol homopolymer and carboxylated anionic polyvinylalcohol copolymer, or a blend of two or more, preferably two polyvinyl alcohol homopolymers, is preferred. The film may be opaque, transparent or translucent. Suitable water-soluble films include those supplied by Monosol under the trade names M8630, M8900, M8779, M8310. The film may comprise a printed area. The area of print may be achieved using techniques such as flexographic printing or inkjet printing. The film may comprise an aversive agent, such as a bittering agent selected from, but are not limited to, naringin, sucrose octaacetate, quinine hydrochloride, denatonium benzoate, or mixtures thereof. The aversive agent include can be added at a level of from 1.0 to 5000 ppm, or 100 to 2500 ppm, or 250 to 2000 ppm.

### Surfactant System

The detergent composition can comprise the surfactant system at a level of from 2.5% to 70%, preferably from 7.0% to 50%, more preferably from 15% to 35% by weight of the composition.

Suitable surfactants as used herein means surfactants or mixtures of surfactants that provide cleaning, stain removing, or laundering benefit to soiled material. Suitable detersive surfactants can be: anionic surfactant, nonionic surfactant, zwitterionic surfactant, and combinations thereof.

The surfactant system comprises alkyl sulfate anionic surfactant. The surfactant system can comprise a surfactant selected from the group consisting of: anionic surfactant, amphoteric surfactant, and mixtures thereof. As such, the surfactant system can comprise a combination of anionic and nonionic surfactant, more preferably a combination of anionic surfactant, nonionic surfactant, and amphoteric surfactant.

A liquid detergent composition can include a first surfactant comprising a branched alkyl sulfate and a second surfactant comprising an anionic, nonionic or amphoteric surfactant. The liquid detergent composition may comprise from about 5% to about 60% by weight of total surfactant. The liquid detergent composition may comprise from about 5%, 6%, 7%, 8%, 9%, or 10% to about 8%, 9%, 10%, 12%, 14%, 16%, 18%, 20%, 22%, 24%, 26%, 28%, 30%, 32%, 34%, 36%, 38%, 40%, 45%, 50%, or any combination thereof, by weight of the composition of total surfactant. The ratio by weight of the first surfactant to the second surfactant can be from about 10:1 to about 1:2, from about 7:1 to about 1:2, from about 5:1 to about 1:2, from about 3:1 to about 1:2, from about 2:1 to about 1:2, or about 1:1. The liquid detergent composition may also comprise from about 1% to about 95% of a carrier, like water. The liquid detergent composition can be a laundry detergent composition. A liquid “laundry detergent composition” includes any composition capable of cleaning fabric in a washing machine or in a hand wash context. The liquid laundry detergent compositions can be used in high efficiency and standard washing machines, in addition to hand washing in a tub or basin for example.

### Branched Alkyl Sulfate Anionic Surfactant

A liquid detergent composition can comprise from about 1% to about 30% by weight of the composition of a first surfactant comprising a branched alkyl sulfate. The liquid detergent composition may also comprise from about 1%, 2%, 3%, 4%, 5%, 6%, 7%, 8%, 9%, or 10% to about 5%, 6%, 7%, 8%, 9%, 10%, 12%, 14%, 16%, 18%, 20%, 22%, 24%, 26%, 28%, or any combination thereof, by weight of the composition of a branched alkyl sulfate. The branched alkyl sulfate can comprise a 2-alkyl branched alkyl alcohol. 2-alkyl branched alcohols are positional isomers, where the location of the hydroxymethyl group (consisting of a methylene bridge (—CH₂-unit) connected to a hydroxy (—OH) group) on the carbon chain varies. Thus, a 2-alkyl branched alkyl alcohol is generally composed of a mixture of positional isomers. Furthermore, it is well known that fatty alcohols, such as 2-alkyl branched alcohols, and surfactants are characterized by chain length distributions. In other words, fatty alcohols and surfactants are generally made up of a blend of molecules having different alkyl chain lengths (though it is possible to obtain single chain-length cuts). Notably, the 2-alkyl primary alcohols described herein, which may have specific alkyl chain length distributions and/or specific fractions of certain positional isomers, cannot be obtained by simply blending commercially available materials. Specifically, the distribution of from about 50% to about 100% by weight surfactants having m+n=11 is not achievable by blending commercially available materials.

The liquid detergent composition can comprise a first surfactant, wherein said first surfactant consists essentially of a mixture of surfactant isomers of Formula 1 and surfactants of Formula 2:

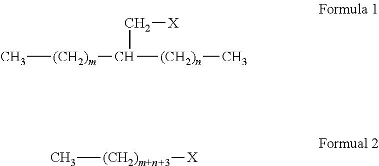

wherein from about 50% to about 100% by weight of the first surfactant are isomers having m+n=11; wherein from about 25% to about 50% of the mixture of surfactant isomers of Formula 1 have n=0; wherein from about 0.001% to about 25% by weight of the first surfactant are surfactants of Formula 2; and wherein X is a hydrophilic moiety.

X can be, for example, neutralized with sodium hydroxide, potassium hydroxide, magnesium hydroxide, lithium hydroxide, calcium hydroxide, ammonium hydroxide, monoethanolamine, diethanolamine, triethanolamine, monoisopropanolamine, diamine, polyamine, primary amine, secondary amine, tertiary amine, amine containing surfactant, or a combination thereof.

X may be selected from sulfates, alkoxylated alkyl sulfates, sulfonates, amine oxides, polyalkoxylates, polyhydroxy moieties, phosphate esters, glycerol sulfonates, polygluconates, polyphosphate esters, phosphonates, sulfosuccinates, sulfosuccinates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sulfates, sorbitan esters, polyalkoxylated sorbitan esters, ammonioalkanesulfonates, amidopropyl betaines, alkylated quats, alkylated/polyhydroxyalkylated quats, alkylated/polyhydroxylated oxypropyl quats, imidazolines, 2-yl-succinates, sulfonated alkyl esters, sulfonated fatty acids, and mixtures thereof.

The first surfactant may have between about 15% to about 40% of the mixture of surfactant isomers of Formula 1 have n=1, such as, for example between about 20% to about 40%, between about 25% to about 35%, or between about 30% to about 40%. The first surfactant may have between about 60% to about 90% of the mixture of surfactant isomers of Formula 1 have n<3, such as, for example between about 65% and 85%, between about 70% and 90%, or between about 80% and 90%. The detergent composition may have between about 90% to about 100% of the first surfactant where the isomers have m+n=11, such as, for example between about 95% and 100%.

The first surfactant may have from about 15% to about 40% by weight of the first surfactant mixture are isomers of Formula 1 with n=1 and from about 5% to about 20% by weight of the first surfactant mixture are isomers of Formula 1 with n=2. The first surfactant may have no isomers of Formula 1 with n equal to or greater than 6. The first surfactant may have up to about 40% of the mixture of surfactant isomers of Formula 1 with n>2. The first surfactant may have up to about 25% of the mixture of surfactant isomers of Formula 1 have n>2. The first surfactant may have up to about 20% by weight of the Formula 2 isomer.

### Impurities

The process of making the 2-alkyl primary alcohol-derived surfactants described above may produce various impurities and/or contaminants at different steps of the process.

The C14 olefin and C12 olefin sources used in the hydroformylation to make the starting C15 aldehydes and C13 aldehydes and subsequent alcohols and corresponding surfactants of use in the present invention may have low levels of impurities that lead to impurities in the starting C15 alcohols and C13 alcohol and therefore also in the C15 alkyl sulfate and C13 alkyl sulfate. While not intending to be limited by theory, such impurities present in the C14 olefin and C12 olefin feeds can include vinylidene olefins, branched olefins, paraffins, aromatic components, and low levels of olefins having chain-lengths other than the intended 14 carbons or 12 carbons. Branched and vinylidene olefins are typically at or below 5% in C14 and C12 alpha olefin sources. Impurities in the resulting C15 alcohols and C13 alcohols can include low levels of linear and branched alcohols in the range of C10 to C17 alcohols, especially C11 and C15 alcohols in the C13 alcohol, and especially C13 and C17 alcohols in the C15 alcohol, typically less than 5% by weight of the mixture, preferably less than 1%; low levels of branching in positions other than the 2-alkyl position resulting from branched and vinylidene olefins are typically less than about 5% by weight of the alcohol mixture, preferably less than 2%; paraffins and olefins, typically less than 1% by weight of the alcohol mixture, preferably less than about 0.5%; low levels of aldehydes with a carbonyl value typically below 500 mg/kg, preferably less than about 200 mg/kg. These impurities in the alcohol can result in low levels of paraffin, linear and branched alkyl sulfates having total carbon numbers other than C15 or C13, and alkyl sulfates with branching in positions other than the 2-alkyl location, wherein these branches can vary in length, but are typically linear alkyl chains having from 1 to 6 carbons. The step of hydroformylation may also yield impurities, such as linear and branched paraffins, residual olefin from incomplete hydroformylation, as well as esters, formates, and heavy-ends (dimers, trimers). Impurities that are not reduced to alcohol in the hydrogenation step may be removed during the final purification of the alcohol by distillation.

Also, it is well known that the process of sulfating fatty alcohols to yield alkyl sulfate surfactants also yields various impurities. The exact nature of these impurities depends on the conditions of sulfation and neutralization. Generally, however, the impurities of the sulfation process include one or more inorganic salts, unreacted fatty alcohol, and olefins (“The Effect of Reaction By-Products on the Viscosities of Sodium Lauryl Sulfate Solutions,” Journal of the American Oil Chemists' Society, Vol. 55, No. 12, p. 909-913 (1978), C. F. Putnik and S. E. McGuire).

### Additional Anionic Surfactants

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C 22 alkyl, or acyl group. Such surfactants are employed in the form of water-soluble salts and the salt-forming cation usually is selected from sodium, potassium, ammonium, magnesium and mono-, with the sodium cation being the usual one chosen.

Anionic surfactants of the present invention and adjunct anionic cosurfactants, may exist in an acid form, and said acid form may be neutralized to form a surfactant salt which is desirable for use in the present detergent compositions. Typical agents for neutralization include the metal counterion base such as hydroxides, e.g., NaOH or KOH. Further preferred agents for neutralizing anionic surfactants of the present invention and adjunct anionic surfactants or cosurfactants in their acid forms include ammonia, amines, oligoamines, or alkanolamines. Alkanolamines are preferred. Suitable non-limiting examples including monoethanolamine, diethanolamine, triethanolamine, and other linear or branched alkanolamines known in the art; for example, highly preferred alkanolamines include 2-amino-1-propanol, 1-aminopropanol, monoisopropanolamine, or 1-amino-3-propanol. Amine neutralization may be done to a full or partial extent, e.g. part of the anionic surfactant mix may be neutralized with sodium or potassium and part of the anionic surfactant mix may be neutralized with amines or alkanolamines.

Suitable sulphonate surfactants include methyl ester sulphonates, alpha olefin sulphonates, alkyl benzene sulphonates, especially alkyl benzene sulphonates, preferably C10-13 alkyl benzene sulphonate. Suitable alkyl benzene sulphonate (LAS) is obtainable, preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic surfactant is alkyl benzene sulphonate that is obtained by DETAL catalyzed process, although other synthesis routes, such as HF, may also be suitable. In one aspect a magnesium salt of LAS is used.

Preferably, the composition may contain from about 0.5% to about 30%, by weight of the laundry composition, of an HLAS surfactant selected from alkyl benzene sulfonic acids, alkali metal or amine salts of C10-16 alkyl benzene sulfonic acids, wherein the HLAS surfactant comprises greater than 50% C12, preferably greater than 60%, preferably greater than 70% C12, more preferably greater than 75%

Suitable sulphate surfactants include alkyl sulphate, preferably C8-18 alkyl sulphate, or predominantly C12 alkyl sulphate.

A preferred sulphate surfactant is alkyl alkoxylated sulphate, preferably alkyl ethoxylated sulphate, preferably a C8-18 alkyl alkoxylated sulphate, preferably a C8-18 alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C8-18 alkyl ethoxylated sulphate having an average degree of ethoxylation of from 0.5 to 10, preferably from 0.5 to 5, more preferably from 0.5 to 3 or from about 1.5 to 3 or from about 1.8 to 2.5. The alkyl alkoxylated sulfate may have a broad alkoxy distribution or a peaked alkoxy distribution. The alkyl portion of the AES may include, on average, from 13.7 to about 16 or from 13.9 to 14.6 carbons atoms. At least about 50% or at least about 60% of the AES molecule may include having an alkyl portion having 14 or more carbon atoms, preferable from 14 to 18, or from 14 to 17, or from 14 to 16, or from 14 to 15 carbon atoms.

Suitable low ethoxylated branched alkyl sulfate surfactants can be derived from alkyl alcohols such as Lial® 145, Isalchem® 145, both supplied by Sasol, optionally blending with other alkyl alcohols in order to achieve the desired branching distributions. Preferably, the composition may contain from about 0.5% to about 20%, more preferably 1% to 10% and even more preferably 2% to 5% by weight of the laundry composition alkyl alkoxylated sulphate.

Processes to make such alkyl ether sulfate anionic surfactants may result in trace residual amounts of 1,4-dioxane by-product being present. The amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. An alternative is to use alkyl sulfate anionic surfactants which comprise only low levels of ethoxylation, or even being free of ethoxylation. As such, the alkyl sulfate surfactant can have a degree of ethoxylation of less than 1.0, or less than 0.5, or even be free of ethoxylation.

The surfactant system may comprise further anionic surfactants, which includes sulfonate surfactants. The surfactant system can comprise sulfonate anionic surfactant at a level of from 3.0% to 30%, preferably from 5.0% to 25.0%, more preferably from 10% to 20% of the liquid laundry detergent composition. The sulfonate anionic surfactant can be selected from the group consisting of: alkylbenzene sulfonates, alkyl ester sulfonates, alkane sulfonates, alkyl sulfonated polycarboxylic acids, and mixtures thereof, preferably alkylbenzene sulfonates, alkyl ester sulfonates, alkane sulfonates, and mixtures thereof, more preferably alkylbenzene sulfonates. A combination of linear alkyl benzene sulfonate and alkyl sulfate surfactant is particularly preferred, and also improves stain removal.

The anionic surfactant can comprise sulfonate anionic surfactant, alkyl sulfate anionic surfactant, and mixtures thereof, preferably a mixture of sulfonate anionic surfactant and alkyl sulfate anionic surfactant. For improved stability and grease cleaning, the liquid detergent composition can comprise a combination of sulfonate surfactant and alkyl sulfate surfactant, preferably such that the ratio of linear alkyl benzene sulfonate surfactant to alkyl alkoxylated sulfate surfactant is in a weight ratio of from 4:1 to 1:1.

Anionic sulfonate or sulfonic acid surfactants suitable for use herein include the acid and salt forms of alkylbenzene sulfonates, alkyl ester sulfonates, alkane sulfonates, alkyl sulfonated polycarboxylic acids, and mixtures thereof. Suitable anionic sulfonate or sulfonic acid surfactants include: C5-C20 alkylbenzene sulfonates, more preferably C10-C16 alkylbenzene sulfonates, more preferably C11-C13 alkylbenzene sulfonates, C5-C20 alkyl ester sulfonates, C6-C22 primary or secondary alkane sulfonates, C5-C20 sulfonated polycarboxylic acids, and any mixtures thereof, but preferably C11-C13 alkylbenzene sulfonates. The aforementioned surfactants can vary widely in their 2-phenyl isomer content.

Other suitable anionic surfactants include fatty acids and their salts, which are typically added as builders. However, by nature, every anionic surfactant known in the art of detergent compositions may be used, such as disclosed in “Surfactant Science Series”, Vol. 7, edited by W. M. Linfield, Marcel Dekker.

Other suitable anionic surfactants for use herein include fatty methyl ester sulfonates and/or alkyl polyalkoxylated carboxylates, for example, alkyl ethoxylated carboxylates (AEC).

The anionic surfactants are typically present in the form of their salts with alkanolamines or alkali metals such as sodium and potassium.

### Nonionic Surfactant

The surfactant system may comprise nonionic surfactant. The nonionic surfactant is preferably selected from alkoxylated alkyl alcohol nonionic surfactant, alkyl polyglucoside, and mixtures thereof, more preferably wherein the nonionic surfactant comprises alkyl polyglucoside nonionic surfactant.

The surfactant system can comprise alkyl polyglucoside nonionic surfactant. The surfactant system can comprise the alkyl polyglucoside (“APG”) at a level of from 0.5% to 10%, preferably from 1.0% to 8.0%, more preferably from 2.0% to 6.0% by weight of the composition.

For improved whiteness, the alkyl polyglucoside surfactant can have a number average alkyl carbon chain length from 8 to 16, preferably from 10 to 14, most preferably from 12 to 14, with an average degree of polymerization of from 0.1 to 3.0, preferably from 1.0 to 2.0, most preferably from 1.2 to 1.6.

C8-C18 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

The surfactant system can comprise further nonionic surfactant, preferably at low levels such as less than 5.0%, preferably from 0.1% to 3.0%, more preferably from 0.5% to 2.0% by weight of the composition. More preferably, the composition comprises less than 0.5% of further nonionic surfactant, and is even more preferably free of further nonionic surfactant.

Suitable non-ionic surfactants are selected from the group consisting of: C8-C18 alkyl ethoxylates, such as, NEODOL® non-ionic surfactants from Shell; C6-C12 alkyl phenol alkoxylates wherein preferably the alkoxylate units are ethyleneoxy units, propyleneoxy units or a mixture thereof; C12-C18 alcohol and C6-C12 alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic surfactants are alkylpolyglucoside and/or an alkyl alkoxylated alcohol.

Suitable non-ionic surfactants include alkyl alkoxylated alcohols, preferably C8-18 alkyl alkoxylated alcohol, preferably a C8-18 alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C8-18 alkyl ethoxylated alcohol having an average degree of ethoxylation of from 1 to 10, preferably from 1 to 7, more preferably from 1 to 5 and most preferably from 3 to 7. In one aspect, the alkyl alkoxylated alcohol is a C12-15 alkyl ethoxylated alcohol having an average degree of ethoxylation of from 7 to 10. The alkyl alkoxylated alcohol can be linear or branched, and substituted or un-substituted. Suitable nonionic surfactants include those with the trade name Lutensol® from BASF. The alkyl alkoxylated sulfate may have a broad alkoxy distribution for example Alfonic 1214-9 Ethoxylate or a peaked alkoxy distribution for example Novel 1214-9 both commercially available from Sasol.

Alkylpolysaccharides such as disclosed in U.S. Pat. No. 4,565,647 Llenado are also useful nonionic surfactants in the compositions of the invention.

Amphoteric and/or Zwitterionic Surfactant

The surfactant system can comprise amphoteric and/or zwitterionic surfactant at a level of from 0.1% to 2.0%, preferably from 0.1% to 1.0%, more preferably from 0.1% to 0.5% by weight of the liquid laundry detergent composition.

Suitable amphoteric surfactants include amine oxide surfactants. Amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R_{y} are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C12-C14 dimethyl amine oxide (lauryl dimethylamine oxide), commercially available from Albright & Wilson, C12-C14 amine oxides commercially available under the trade name Genaminox® LA from Clariant or AROMOX® DMC from AKZO Nobel.

Suitable amphoteric or zwitterionic detersive surfactants include those which are known for use in hair care or other personal care cleansing. Non-limiting examples of suitable zwitterionic or amphoteric surfactants are described in U.S. Pat. Nos. 5,104,646, 5,106,609. Suitable amphoteric detersive surfactants include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulfonate, sulfate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.

### Additional Optional Ingredients

The detergent composition may additionally comprise one or more of the following optional ingredients: external structurant or thickener, enzymes, enzyme stabilizers, cleaning polymers, bleaching systems, optical brighteners, hueing dyes, particulate material, perfume and other odour control agents, hydrotropes, suds suppressors, fabric care benefit agents, pH adjusting agents, dye transfer inhibiting agents, dye fixative polymers, preservatives, non-fabric substantive dyes and mixtures thereof. In more preferred embodiments, the laundry detergent composition does not comprise a bleach.

External structurant or thickener: Preferred external structurants and thickeners are those that do not rely on charge-charge interactions for providing a structuring benefit. As such, particularly preferred external structurants are uncharged external structurants, such as those selected from the group consisting of: non-polymeric crystalline, hydroxyl functional structurants, such as hydrogenated castor oil; microfibrillated cellulose; uncharged hydroxyethyl cellulose; uncharged hydrophobically modified hydroxyethyl cellulose; hydrophobically modified ethoxylated urethanes; hydrophobically modified non-ionic polyols; and mixtures thereof.

Suitable polymeric structurants include naturally derived and/or synthetic polymeric structurants.

Examples of naturally derived polymeric structurants of use in the detergent compositions detailed herein include: microfibrillated cellulose, hydroxyethyl cellulose, hydrophobically modified hydroxyethyl cellulose, carboxymethyl cellulose, polysaccharide derivatives and mixtures thereof. Non-limiting examples of microfibrillated cellulose are described in WO2009/101545A. Suitable polysaccharide derivatives include: pectine, alginate, arabinogalactan (gum Arabic), carrageenan, gellan gum, xanthan gum, guar gum and mixtures thereof.

Examples of synthetic polymeric structurants or thickeners of use in the present invention include: polycarboxylates, hydrophobically modified ethoxylated urethanes (HEUr), hydrophobically modified non-ionic polyols and mixtures thereof.

Preferably, the aqueous liquid detergent composition has a viscosity of 50 to 5,000, preferably 75 to 1,000, more preferably 100 to 500 mPa·s, when measured at a shear rate of 100 s−1, at a temperature of 20° C. For improved phase stability, and also improved stability of suspended ingredients, the aqueous liquid detergent composition has a viscosity of 50 to 250,000, preferably 5,000 to 125,000, more preferably 10,000 to 35,000 mPa·s, when measured at a shear rate of 0.05 s−1, at a temperature of 20° C.

Cleaning polymers: The detergent composition preferably comprises a cleaning polymer. Such cleaning polymers are believed to at least partially lift the stain from the textile fibres and enable the enzyme system to more effectively break up the complexes comprising mannan and other polysaccharide. Suitable cleaning polymers provide for broad-range soil cleaning of surfaces and fabrics and/or suspension of the soils. Non-limiting examples of suitable cleaning polymers include: amphiphilic alkoxylated grease cleaning polymers; clay soil cleaning polymers; soil release polymers; and soil suspending polymers. A preferred cleaning polymer is obtainable by free-radical copolymerization of at least one compound of formula (I),
in which n is equal to or greater than 3 for a number,
with at least one compound of formula (II),
in which A⁻ represents an anion, in particular selected from halides such as fluoride, chloride, bromide, iodide, sulfate, hydrogen sulfate, alkyl sulfate such as methyl sulfate, and mixtures thereof. Such polymers are further described in EP3196283A1.

For similar reasons, polyester based soil release polymers, such as SRA300, supplied by Clariant are also particularly preferred.

Other useful cleaning polymers are described in US20090124528A. The detergent composition may comprise amphiphilic alkoxylated grease cleaning polymers, which may have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkyleneimines, for example. Such compounds may comprise, but are not limited to, ethoxylated polyethyleneimine, ethoxylated hexamethylene diamine, and sulfated versions thereof. Polypropoxylated derivatives may also be included. A wide variety of amines and polyalkyleneimines can be alkoxylated to various degrees. A useful example is 600 g/mol polyethyleneimine core ethoxylated to 20 EO groups per NH and is available from BASF. The alkoxylated polyalkyleneimines may have an inner polyethylene oxide block and an outer polypropylene oxide block. The detergent compositions may comprise from 0.1% to 10%, preferably, from 0.1% to 8.0%, more preferably from 0.1% to 2.0%, by weight of the detergent composition, of the cleaning polymer.
dye transfer inhibiting polymers: the detergent composition can comprise one or more dye transfer inhibiting polymer, however, preferred compositions do not comprise such dye transfer inhibiting polymers. it has been found that during laundering, many fabric-dyes partition between the fabric and wash-liquor. as such, the sequestering of dyes in the wash liquor using dti polymers has been found to increase dye removal from fabrics and hence increase dye-fading.

When used, suitable dye transfer inhibiting can be selected from the group consisting of polyvinylpyrrolidone (PVP), polyvinylimidazole (PVI), copolymers of vinylpyrrolidone and vinylimidazole (PVP/PVI), polyvinyl pyridine-n-oxide, poly-n-carboxymethyl-4-vinylpyridiumchloride, poly(2-hydroxypropyldimethylammonium chloride), and mixtures thereof, preferably polyvinylpyrrolidone (PVP), polyvinylimidazole (PVI), copolymers of vinylpyrrolidone and vinylimidazole (PVP/PVI), and mixtures thereof. If present, the dye transfer inhibitor can be present at a level of from 0.05% to 5%, or from 0.1% to 3%, and or from 0.2% to 2.5%, by weight of the detergent composition.

Polyvinylpyrrolidone (“PVP”) has an amphiphilic character with a highly polar amide group conferring hydrophilic and polar attracting properties, and also has apolar methylene and methane groups, in the backbone and/or the ring, conferring hydrophobic properties. The rings may also provide planar alignment with the aromatic rings, in the dye molecules. PVP is readily soluble in aqueous and organic solvent systems. PVP is commercially available in either powder or aqueous solutions in several viscosity grades. The compositions of the present invention preferably utilize a copolymer of N-vinylpyrrolidone and N-vinylimidazole (also abbreviated herein as “PVPVI”). It has been found that copolymers of N-vinylpyrrolidone and N-vinylimidazole can provide excellent dye transfer inhibiting performance. The copolymers of N-vinylpyrrolidone and N-vinylimidazole can have a molar ratio of N-vinylimidazole to N-vinylpyrrolidone from 1:1 to 0.2:1, more preferably from 0.8:1 to 0.3:1, most preferably from 0.6:1 to 0.4:1. The copolymer of N-vinylpyrrolidone and N-vinylimidazole can be either linear or branched. Particularly suitable Polyvinylpyrrolidones (PVP), polyvinylimidazoles (PVI), and copolymers of vinylpyrrolidone and vinylimidazole (PVP/PVI), can have a weight average molecular weight of from 5,000 Da to 1,000,000 Da, preferably from 5,000 Da to 50,000 Da, more preferably from 10,000 Da to 20,000 Da. The number average molecular weight range is determined by light scattering as described in Barth J. H. G. and Mays J. W. Chemical Analysis Vol 1 13. “Modern Methods of Polymer Characterization.” Copolymers of poly(N-vinyl-2-pyrollidone) and poly(N-vinyl-imidazole) are commercially available from a number of sources including BASF. A preferred DTI is commercially available under the tradename Sokalan® HP 56 K from BASF (BASF SE, Germany).

Organic builder and/or chelant: the laundry detergent composition can comprise from 0.6% to 10%, preferably from 2 to 7% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy diphosphonates, and nitrilotrimethylene, phosphonates, diethylene triamine penta (methylene phosphonic acid) (DTPMP), ethylene diamine tetra(methylene phosphonic acid) (EDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulfonates such as Tiron™ and mixtures thereof.

ENZYMES: The detergent composition can comprise at least one enzyme, preferably an esterase enzyme.

Esterases, also often referred to as hydrolases, are a group consisting of enzymes defined by their ability to catalyze the hydrolysis of carboxylic ester bonds. Lipases are lipolytic enzymes which constitute a class of esterases capable of releasing fatty acids, especially long chain fatty acids, from natural water-insoluble carboxylic esters. As such, they are commonly referred to as lipid esterases. Esterases, such as lipase have been found to be particularly effective at improving cleaning during low temperature laundering.

The esterase enzyme can be present in the detergent composition, such that in the wash liquor of at least one wash step, the lipase is present at a level of from 0.001 to 2.5 ppm, preferably from 0.01 to 1.5 ppm, more preferably from 0.025 to 0.75 ppm.

The esterase can be selected from E.C. class 3.1. The esterase is preferably selected from the group consisting of:
f) lipase (E.C. 3.1.1.3);
f) carboxylic ester hydrolase (E.C. 3.1.1.1);
f) cutinase (E.C. 3.1.1.74);
f) sterol esterase (E.C. 3.1.1.13);
f) wax-ester hydrolase (E.C. 3.1.1.50);
f) and mixtures thereof.

The “E.C. class” refers to the Enzyme Commission class. The Enzyme Commission class is an international recognized enzyme classification scheme based on chemical reactions that the enzymes catalyse.

The esterase preferably comprises, more preferably consists of lipase. The lipase enzyme, also referred to as lipid esterase, preferably comprises a triacylglycerol lipase. Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g. such as those described in WO2006/090335 and WO2013/116261. In one aspect, the lipase is a first-wash lipase, preferably a variant of the wild-type lipase from Thermomyces lanuginosus comprising T231R and/or N233R mutations. The lipase may also be as those described in WO2017001673, WO2017005640, WO2022090361, WO2016102356, WO2016091870, WO201801959, US201850047, US20180037876, WO2018202846 and US20190233804.

Preferred lipases include those sold under the tradenames Lipex®, Lipolex® and Lipoclean® and Lipoprime® by Novozymes, Bagsvaerd, Denmark.

Other suitable lipases include: Liprl 139, as described in WO2013/171241; TfuLip2, as described in WO2011/084412 and WO2013/033318; Pseudomonas stutzeri lipase, as described in WO2018228880; Microbulbifer thermotolerans lipase, as described in WO2018228881; Sulfobacillus acidocaldarius lipase, as described in EP3299457; LIP062 lipase as described in WO2018209026; PinLip lipase as described in WO2017036901, Absidia sp. lipase as described in WO2017005798, WO2017005816, WO2021001400, US20190390182; Pichia Pastoris lipase as described in WO2019206994; Proteus vulgaris lipase as described in WO2020046613; Vulcanisaeta moutnovskia lipase as described in WO2020104159; Pseudomonas mendocina lipase as described in WO2023278297, WO2023274925, WO2023247922, WO2023274923 and WO2022/197810; and Geotrichum candidum lipase as described in WO/2022/162043.

Suitable carboxylic ester hydrolases can be selected from wild-types or variants of carboxylic ester hydrolases endogenous to B. gladioli, P. fluorescens, P. putida, B. acidocaldarius, B. subtilis, B. stearothermophilus, Streptomyces chrysomallus, S. diastatochromogenes and Saccharomyces cerevisiae. Other suitable carboxylic ester hydrolases may be selected from Thermogutta terrifontis and Archaeoglobus fulgidus (WO2020104157A). Suitable cutinases can be selected from wild-types or variants of cutinases endogenous to strains of Aspergillus, in particular Aspergillus oryzae, a strain of Alternaria, in particular Alternaria brassiciola, a strain of Fusarium, in particular Fusarium solani, Fusarium solani pisi, Fusarium oxysporum, Fusarium oxysporum cepa, Fusarium roseum culmorum, or Fusarium roseum sambucium, a strain of Helminthosporium, in particular Helminthosporium sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, a strain of Coprinopsis, in particular Coprinopsis cinerea, a strain of Thermobifida, in particular Thermobifida fusca, a strain of Magnaporthe, in particular Magnaporthe grisea, or a strain of Ulocladium, in particular Ulocladium consortiale.

The cutinase can be selected from variants of the Pseudomonas mendocina cutinase described in WO 2003/076580 (Genencor), such as the variant with three substitutions at 1178M, F180V, and S205G.

The cutinase can be a wild-type or variant of the six cutinases endogenous to Coprinopsis cinerea described in H. Kontkanen et al, App. Environ. Microbiology, 2009, p 2148-2157.

The cutinase can be a wild-type or variant of the two cutinases endogenous to Trichoderma reesei described in WO2009007510 (VTT). In another preferred embodiment the cutinase is derived from a strain of Humicola insolens, in particular the strain Humicola insolens DSM 1800. Humicola insolens cutinase is described in WO 96/13580. The cutinase may be a variant, such as one of the variants disclosed in WO00/34450A and WO01/92502A. Preferred cutinase variants include variants listed in Example 2 of WO01/92502A.

Suitable sterol esterases may be derived from a strain of Ophiostoma, for example Ophiostoma piceae, a strain of Pseudomonas, for example Pseudomonas aeruginosa, or a strain of Melanocarpus, for example Melanocarpus albomyces. Other suitable sterol esterases are the Melanocarpus albomyces sterol esterase described in H. Kontkanen et al, Enzyme Microb Technol., 39, (2006), 265-273 and Corynebacterium sterol esterase (WO2020104158A).

Suitable wax-ester hydrolases may be derived from Simmondsia chinensis.

The composition can comprise further enzymes. Suitable further enzymes can provide cleaning performance and/or fabric care benefits. Examples of suitable enzymes include, but are not limited to, hemicellulases, peroxidases, proteases, cellulases, xylanases, phospholipases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises a cocktail of conventional detersive enzymes such as protease, lipase, cutinase and/or cellulase in conjunction with amylase. Detersive enzymes are described in greater detail in U.S. Pat. No. 6,579,839.

Such further enzymes can be present in the detergent composition, such that the further enzyme or enzymes are present in the wash liquor of at least one wash step at a level of from 0.001 to 2.5 ppm, preferably from 0.01 to 1.5 ppm, more preferably from 0.025 to 0.75 ppm.

Enzyme stabiliser: enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.G. Certain esters, dialkyl glycol ethers, alcohols or alcohol alkoxylates], alkyl ether carboxylate in addition to a calcium ion source, benzamidine hypochlorite, lower aliphatic alcohols and carboxylic acids, n,n-bis(carboxymethyl) serine salts; (meth)acrylic acid-(meth)acrylic acid ester copolymer and PEG; lignin compound, polyamide oligomer, glycolic acid or its salts; poly hexa methylene bi guanide or n,n-bis-3-amino-propyl-dodecyl amine or salt; and mixtures thereof.

Hueing dyes: The detergent composition may comprise fabric hueing agent (sometimes referred to as shading, bluing, or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifuranone and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and combinations thereof.

Optical brighteners: The detergent composition may comprise, based on the total detergent composition weight, from 0.005% to 2.0%, preferably 0.01% to 0.1% of a fluorescent agent (optical brightener). Fluorescent agents are well known and many fluorescent agents are available commercially. Usually, these fluorescent agents are supplied and used in the form of their alkali metal salts, for example, the sodium salts. Preferred classes of fluorescent agent are: Di-styryl biphenyl compounds, e.g. Tinopal® CBS-X, Di-amine stilbene di-sulfonic acid compounds, e.g. Tinopal® DMS pure Xtra and Blankophor® HRH, and Pyrazoline compounds, e.g. Blankophor® SN. Preferred fluorescers are: sodium 2-(4-styryl-3-sulfophenyl)-2H-napthol [1,2-d]triazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl) biphenyl.

Hydrotrope: The detergent composition may comprise, based on the total detergent composition weight, from 0 to 30%, preferably from 0.5 to 5%, more preferably from 1.0 to 3.0%, which can prevent liquid crystal formation. The addition of the hydrotrope thus aids the clarity/transparency of the composition. Suitable hydrotropes comprise but are not limited to urea, salts of benzene sulfonate, toluene sulfonate, xylene sulfonate or cumene sulfonate. Preferably, the hydrotrope is selected from the group consisting of propylene glycol, xylene sulfonate, ethanol, and urea to provide optimum performance.

Particles: The composition can also comprise particles, especially when the composition further comprises a structurant or thickener. The composition may comprise, based on the total composition weight, from 0.02% to 10%, preferably from 0.1% to 4.0%, more preferably from 0.25% to 2.5% of particles. Said particles include beads, pearlescent agents, capsules, and mixtures thereof.

Suitable capsules are typically formed by at least partially, preferably fully, surrounding a benefit agent with a wall material. Preferably, the capsule is a perfume capsule, wherein said benefit agent comprises one or more perfume raw materials. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof. Preferably, the capsule wall comprises melamine and/or a polyacrylate based material. The perfume capsule may be coated with a deposition aid, a cationic polymer, a non-ionic polymer, an anionic polymer, or mixtures thereof. Preferably, the perfume capsules have a volume weighted mean particle size from 0.1 microns to 100 microns, preferably from 0.5 microns to 60 microns. Especially where the composition comprises capsules having a shell formed at least partially from formaldehyde, the composition can additionally comprise one or more formaldehyde scavengers.

The detergent composition can comprise organic solvent, preferably wherein the organic solvent is selected from the group consisting of: C1-C5 alkanols, C2-C6 diols, C3-C8 alkylene glycols, C3-C8 alkylene glycol mono lower alkyl ethers, glycol dialkyl ether, polyethylene glycols, C3-C9 triols, and mixtures thereof; more preferably wherein the organic solvent comprises C1-C5 alkanols, C2-C6 diols, C3-C9 triols, and mixtures thereof; more preferably wherein the organic solvent comprises ethanol, 1,2-propanediol, glycerol, and mixtures thereof. The detergent composition can comprise organic solvent at a level of from 0.5% to 50%, preferably from 1.0% to 35%, more preferably from 2.0% to 15% by weight of the detergent composition.

### Fabric Conditioning Compositions

In the methods detailed herein, the fabrics are treated with a fabric conditioning composition, with fabric softener being typically applied during the rinse step, but the conditioning composition may also treat the fabrics during the wash step with products such as softening beads or granules, etc.

### Liquid Fabric Conditioning Compositions

When the fabric is treated with a liquid fabric conditioning composition, it is typically an aqueous liquid fabric conditioning composition comprising alkyl quaternary ammonium ester materials, also often called “ester quats”. Such ester quats are useful for providing conditioning benefits such as softness, anti-wrinkle, anti-static, conditioning, anti-stretch, color, and/or appearance benefits to target fabrics.

The liquid conditioning composition may comprise from 2% to 30%, or from 2% to 24%, or from 2% to 18%, or from 2% to 13%, by weight of the liquid conditioning composition, of the ester quat softening active.

The liquid conditioning composition can have been added during the rinse step of a prior wash cycle, such that the ester quat softening active was present in the rinse liquor at a level of greater than 1 ppm or from 1 ppm to 2000 ppm, preferably from 5 ppm to 950 ppm, more preferably from 7 ppm to 750 ppm.

### Esterquat Softening Active

Suitable quaternary ammonium ester softening actives include, but are not limited to, materials selected from the group consisting of: monoester quats, diester quats, triester quats and mixtures thereof.

Preferably, the level of monoester quat is from 2.0% to 40.0%, the level of diester quat is from 40.0% to 98.0%, the level of triester quat is from 0.0% to 25.0% by weight of total quaternary ammonium ester softening active.

Suitable quaternary ammonium ester softening active may comprise compounds of the following formula:

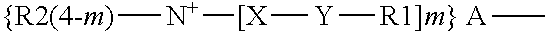

wherein:
m is 1, 2 or 3 with proviso that the value of each m is identical;
each R1 is independently hydrocarbyl, or branched hydrocarbyl group, preferably R1 is linear, more preferably R1 is partially unsaturated linear alkyl chain;
each R2 is independently a C1-C3 alkyl or hydroxyalkyl group, preferably R2 is selected from methyl, ethyl, propyl, hydroxyethyl, 2-hydroxypropyl, 1-methyl-2 hydroxyethyl, poly(C2-3-alkoxy), polyethoxy, benzyl;
each X is independently —(CH2)n—, —CH2-CH(CH3)— or —CH(CH3)—CH2— and
each n is independently 1, 2, 3 or 4, preferably each n is 2;
each Y is independently —O—(O)C— or —C(O)—O—;
A- is independently selected from the group consisting of chloride, methyl sulfate, and ethyl sulfate, preferably A- is selected from the group consisting of chloride and methyl sulfate; with the proviso that when Y is —O—(O)C—, the sum of carbons in each R1 is from 13 to 21, preferably from 13 to 19. Preferably, X is —CH2-CH(CH3)— or —CH(CH3)—CH2- to further improve the hydrolytic stability of the quaternary ammonium ester softening active, and hence further improve the stability of the liquid fabric softener composition.

Because of the balance of processability and odor of the quaternary ammonium ester softening active, in preferred liquid fabric softener compositions, the iodine value of the parent fatty acid from which the quaternary ammonium fabric softening active is formed is typically from 0 to 100, more preferably from 10 to 60, even more preferably from 15 to 45.

The ester quat softening actives are typically derived from fatty acid. The fatty acid may be partially hydrogenated, as such processes can provide the desired amount of trans fatty acids. By “partially hydrogenated” as used herein, it is meant that either the fatty acids themselves undergo a partial hydrogenation process, or that the oil from which the fatty acids are derived undergoes a hydrogenation process, or both. Additionally, partial hydrogenation processes reduce the amount of double-unsaturated fatty acids, the presence of which may lead to color and/or odor instabilities in final product.

The fatty acids can be derived from plants. Suitable sources of plant-derived fatty acids include vegetable oils, such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, and the like. Preferably, the fatty acid comprises fatty acids that are derived from cottonseed, rapeseed, sunflower seed, or soybean. These materials are particularly preferred because they tend to produce fatty acids having a desirable trans-unsaturation content upon partial hydrogenation.

The fatty acids may include an alkyl portion containing, on average by weight, from 13 to 22 carbon atoms, or from 14 to 20 carbon atoms, preferably from 16 to 18 carbon atoms, where the carbon count includes the carbon of the carboxyl group. The population of fatty acids may be present in a distribution of alkyl chains sizes.

The alkyl quaternary ammonium ester softening actives may comprise compounds formed from fatty acids that are unsaturated, meaning that the fatty acids comprise at least one double bond in the alkyl portion. The fatty acids may be mono-unsaturated (one double bond), or they may be di-unsaturated (or double-unsaturated; two double bonds). Preferably, most of the unsaturated fatty acids in the fatty acid feedstock are mono-unsaturated.

The fatty acids may comprise unsaturated C18 chains, which may include a single double bond (“C18:1”) or may be double unsaturated (“C18:2”). (For reference, a fatty acid with a saturated C18 chain may be referred to as “C18:0”.) The fatty acid feedstock may comprise from 30% to 85%, preferably from 60% to about 80%, more preferably from 70% to 80%, by weight of the fatty acid feedstock, of C18 fatty acids, regardless of saturated or unsaturated status. The fatty acid feedstock may comprise from 20% to 95%, preferably from 40% to 60%, more preferably from 45% to 55%, by weight of the fatty acid feedstock, of C18:0 fatty acids. The fatty acid feedstock may comprise from 15% to 50%, preferably from 15% to 30%, preferably from 18% to 25%, by weight of the fatty acid feedstock, of C18:1 fatty acids. The fatty acid feedstock may comprise from 0% (e.g., none) to 20%, or from 0% to 15%, or from 0% to 10%, or from 0% to 5%, by weight of the fatty acid feedstock, of C18:2 fatty acids. The fatty acid feedstock may comprise from 1% to 15%, preferably from 5% to 10%, by weight of the fatty acid feedstock, of C18:2 fatty acids.

The ester quat material can be produced in a two-step synthesis process. First, an esteramine can be produced through an esterification reaction using fatty acids and an alkanolamine. In a second step, the product can be quaternized using an alkylating agent.

The liquid conditioning compositions of use in the present invention may comprise other conditioning agents in addition to the ester quats described above. The other conditioning agents may be selected from the group consisting of quaternary ammonium ester compounds other than those described above, silicones, non-ester quaternary ammonium compounds, amines, fatty esters, sucrose esters, silicones, dispersible polyolefins, polysaccharides, fatty acids, softening or conditioning oils, polymer latexes, glyceride copolymers, or combinations thereof.

Examples of suitable quaternary ammonium ester softening actives are commercially available from KAO Chemicals under the trade name Tetraenyl® AT-1 and Tetraenyl® AT-7590, from Evonik under the tradename Rewoquat® WE16 DPG, Rewoquat® WE18, Rewoquat® WE20, Rewoquat® WE28, and Rewoquat® 38 DPG, from Stepan under the tradename Stepantex® GA90, Stepantex® VR90, Stepantex® VK90, Stepantex® VA90, Stepantex® DC90, and Stepantex® VL90A.

These types of agents and general methods of making them are disclosed in U.S. Pat. No. 4,137,180.

The liquid conditioning composition may have a viscosity from about 50 cPs to about 300 cPs (about 50 mPa's to about 300 mPa s), or from 80 cPs to about 300 cPs, or from 90 cPs to about 250 cPs, or preferably from 150 cPs to about 250 cPs. The viscosity is determined using a Brookfield viscometer, No. 2 spindle, at 60 RPM/s, measured at about 22° C. Compositions having viscosities lower than what is provided here may be viewed as too runny and seen as “cheap”; compositions having relatively higher viscosities may result in processing or dispensing challenges.

The liquid conditioning composition may be characterized by a dynamic yield stress. For example, the dynamic yield stress at 20° C. of the fabric softener composition may be from 0.001 Pa to 1.0 Pa, preferably from 0.005 Pa to 0.8 Pa, more preferably from 0.01 Pa to 0.5 Pa. The absence of a dynamic yield stress may lead to phase instabilities such as particle creaming or settling in case the liquid composition comprises suspended particles or encapsulated benefit agents. Very high dynamic yield stresses may lead to undesired air entrapment during filling of a bottle with the fabric softener composition. Dynamic yield stress is determined according to the method provided in the Test Methods section below.

The liquid conditioning compositions of the present disclosure may be characterized by a pH of from about 2 to about 12, or from about 2 to about 8.5, or from about 2 to about 7, or from about 2 to about 5. The compositions of the present disclosure may have a pH of from about 2 to about 4, preferably a pH of from about 2 to about 3.7, more preferably a pH from about 2 to about 3.5, preferably in the form of an aqueous liquid. It is believed that acidic pH levels facilitate stability of the ester quat. The pH of a composition is determined by dissolving/dispersing the composition in deionized water to form a solution at 10% concentration, at about 20° C.

The liquid conditioning compositions of the present disclosure may comprise water. The liquid conditioning composition may comprise from about 40% to about 98%, or from about 50% to about 96%, or from about 75% to about 95%, or from about 80% to about 94%, by weight of the composition, of water. Water levels may be selected to as to balance the amount of the softening active to a desired level. The selection of the ester quats described herein is believed to be particularly useful in compositions that comprise a relatively high amount of water, as such ingredients can provide both performance and viscosity-building benefits.

The liquid conditioning compositions may be packaged in a pouring bottle. The liquid conditioning composition may be packaged in an aerosol can or other spray bottle. The packaging may be translucent or transparent.

The liquid conditioning compositions of the present disclosure may further include one or more of the following ingredients set out below.

### Perfume and Perfume Delivery Systems

The liquid conditioning compositions may comprise perfume, a perfume delivery system, or a combination thereof. Such systems may improve the freshness performance of the compositions described herein. In particular, perfume delivery systems may facilitate improved freshness performance by increasing deposition efficiency, facilitating perfume release at different touchpoints, and/or increasing longevity of perfume performance.

### Neat Perfume

Perfume may be present as neat oil, sometimes referred to as, for example, “free” perfume, unencapsulated perfume, or free perfume oil. The liquid conditioning compositions may comprise from about 0.01% to about 5%, or from about 0.05% to about 4%, or from about 0.1% to about 3%, or from about 0.5% to about 2%, by weight of the composition, or free perfume oil.

Neat oil can comprise perfume raw materials such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, alpha-damascone, beta-damascone, gamma-damascone, beta-damascenone, 6,7-dihydro-1,1,2,3,3-pentamethyl-4 (5H)-indanone, methyl-7,3-dihydro-2H-1,5-benzodioxepine-3-one, 2-[2-(4-methyl-3-cyclohexenyl-1-yl) propyl]cyclopentan-2-one, 2-sec-butylcyclohexanone, and beta-dihydro ionone, linalool, ethyllinalool, tetrahydrolinalool, and dihydromyrcenol; silicone oils, waxes such as polyethylene waxes; essential oils such as fish oils, jasmine, camphor, lavender; skin coolants such as menthol, methyl lactate; vitamins such as Vitamin A and E; sunscreens; glycerine; catalysts such as manganese catalysts or bleach catalysts; bleach particles such as perborates; silicon dioxide particles; antiperspirant actives; cationic polymers and mixtures thereof. Suitable benefit agents can be obtained from Givaudan Corp. of Mount Olive, New Jersey, USA, International Flavors & Fragrances Corp. of South Brunswick, New Jersey, USA, or Firmenich Company of Geneva, Switzerland or Encapsys Company of Appleton, Wisconsin (USA). As used herein, a “perfume raw material” refers to one or more of the following ingredients: fragrant essential oils; aroma compounds; pro-perfumes; materials supplied with the fragrant essential oils, aroma compounds, and/or pro-perfumes, including stabilizers, diluents, processing agents, and contaminants; and any material that commonly accompanies fragrant essential oils, aroma compounds, and/or pro-perfumes.

### Perfume Delivery Systems

The perfume delivery system may comprise encapsulates, for example, where a core is surrounded by wall material (“core-shell encapsulates”); the core may comprise perfume and optionally a partitioning modifier (e.g., isopropyl myristate). The wall material may include melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, or mixtures thereof. The melamine wall material may comprise melamine crosslinked with formaldehyde, melamine-dimethoxyethanol crosslinked with formaldehyde, and mixtures thereof; encapsulates with such wall materials may be used in combination with a formaldehyde scavenger, such as acetoacetamide, urea, or derivatives thereof. The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The polyacrylate ester-based wall materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

The aromatic alcohol-based wall material may comprise aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresols (o-, m-, and p-cresol), naphthols (alpha and beta-naphthol) and thymol, as well as ethylphenols, propylphenols, fluorophenols and methoxyphenols.

The polyurea based wall material may comprise a polyisocyanate. The shell of the delivery particles may comprise a polymeric material that may be the reaction product of a polyisocyanate and a chitosan. The shell may comprise a polyurea resin, where the polyurea resin comprises the reaction product of a polyisocyanate and chitosan. The delivery particles of the present disclosure may be considered polyurea delivery particles and include a polyurea-chitosan shell. (As used herein, “shell” and “wall” are used interchangeably with regard to the delivery particles, unless indicated otherwise.) The shell may be derived from isocyanates and chitosan.

The delivery particles may be made according to a process that comprises the following steps: forming a water phase comprising chitosan in an aqueous acidic medium; forming an oil phase comprising dissolving together at least one benefit agent and at least one polyisocyanate; forming an emulsion by mixing under high shear agitation the water phase and the oil phase into an excess of the water phase, thereby forming droplets of the oil phase and benefit agent dispersed in the water phase; curing the emulsion by heating, for a time sufficient to form a shell at an interface of the droplets with the water phase, the shell comprising the reaction product of the polyisocyanate and chitosan, and the shell surrounding the core comprising the droplets of the oil phase and benefit agent. Diluents, for example isopropyl myristate, may be used to adjust the hydrophilicity of the oil phase. The oil phase is then added into the water phase and milled at high speed to obtain a targeted size. The emulsion is then cured in one or more heating steps.

The temperature and time are selected to be sufficient to form and cure a shell at the interface of the droplets of the oil phase with the water continuous phase. For example, the emulsion is heated to 85° C. in 60 minutes and then held at 85° C. for 360 minutes to cure the particles. The slurry is then cooled to room temperature.

Chitosan (as defined herein in the Chitosan section) as a percentage by weight of the shell may be from about 21% up to about 95% of the shell. The ratio of the isocyanate monomer, oligomer, or prepolymer to chitosan may be up to 1:10 by weight.

The polyisocyanate may be an aliphatic or aromatic monomer, oligomer or prepolymer, usefully comprising two or more isocyanate functional groups. The polyisocyanate may preferably be selected from a group comprising toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, and phenylene diisocyanate.

The polyisocyanate, for example, can be selected from aromatic toluene diisocyanate and its derivatives used in wall formation for encapsulates, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate. The polyisocyanate can be selected from 1,3-diisocyanato-2-methylbenzene, hydrogenated MDI, bis(4-isocyanatocyclohexyl) methane, dicyclohexylmethane-4,4′-diisocyanate, and oligomers and prepolymers thereof. This listing is illustrative and not intended to be limiting of the polyisocyanates useful in the present disclosure.

The polyisocyanates useful in the invention comprise isocyanate monomers, oligomers or prepolymers, or dimers or trimers thereof, having at least two isocyanate groups. Optimal crosslinking can be achieved with polyisocyanates having at least three functional groups. Polyisocyanates, for purposes of the present disclosure, are understood as encompassing any polyisocyanate having at least two isocyanate groups and comprising an aliphatic or aromatic moiety in the monomer, oligomer, or prepolymer. If aromatic, the aromatic moiety can comprise a phenyl, a toluyl, a xylyl, a naphthyl or a diphenyl moiety, more preferably a toluyl or a xylyl moiety. Aromatic polyisocyanates, for purposes herein, can include diisocyanate derivatives such as biurets and polyisocyanurates. The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), or trimethylol propane-adduct of xylylene diisocyanate (commercially available from Mitsui Chemicals under the tradename Takenate® D-110N), naphthalene-1,5-diisocyanate, and phenylene 5 diisocyanate.

There is a preference for aromatic polyisocyanate; however, aliphatic polyisocyanates and blends thereof may be useful. Aliphatic polyisocyanate is understood as a polyisocyanate which does not comprise any aromatic moiety. Aliphatic polyisocyanates include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100). The shell may degrade at least 50% after 20 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

The composition may comprise from about 0.05% to about 20%, or from about 0.05% to about 10%, or from about 0.1% to about 5%, or from about 0.2% to about 2%, by weight of the composition, of delivery particles. The composition may comprise a sufficient amount of delivery particles to provide from about 0.05% to about 10%, or from about 0.1% to about 5%, or from about 0.1% to about 2%, by weight of the composition, of the encapsulated benefit agent, which may preferably be perfume raw materials, to the composition. When discussing herein the amount or weight percentage of the delivery particles, it is meant the sum of the wall material and the core material.

The delivery particles according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 20 to about 30 microns. Different particle sizes are obtainable by controlling droplet size during emulsification.

The delivery particles may be characterized by a ratio of core to shell up to 85:15, up to 90:10, up to 99:1, or even 99.5:0.5 on the basis of weight.

The encapsulates may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, a polysaccharide (e.g., chitosan), and combinations thereof.

The perfume delivery system may comprise particles that comprise a graft copolymer and a fragrance material, where the graft copolymer comprises a polyalkylene glycol (e.g., polyethylene glycol) as a graft base and one or more side chains that comprise vinyl acetate moieties.

The perfume delivery system may comprise a pro-perfume, for example a silicate ester-based pro-perfume, where a perfume raw material is associated with (for example, via covalent bonding) a polymer (e.g., a silicate ester polymer) upon delivery to a surface and is released upon or after treatment of a surface with the composition.

The perfume delivery system may comprise self-assembling particles composed of rosin materials, such as gum rosin, wood rosin, tall oil rosin, or their derivatives, preferably their ester derivatives, even more preferably their glycerol ester derivatives. Particles may be obtained by a self-assembling process. The self-assembling process involves adding the plant rosin material, either with or after the perfume, to the product composition. Optionally, an emulsifying agent can be included to aid in particle formation within the final product. The preferred perfume raw materials to be encapsulated within these self-assembling particles are those that contain a moiety selected from a cycloalkane, a cycloalkene, a branched alkane, or a combination thereof. The particle size can range from 10 μm to 90 μm.

When the perfume delivery system includes formaldehyde derivatives, such as perfume encapsulates with melamine-formaldehyde shells, the composition may further comprise a formaldehyde scavenger, which may comprise a sulfur-based formaldehyde scavenger, a non-sulfur-based formaldehyde scavenger, or mixtures thereof. Suitable non-sulfur-based formaldehyde scavengers may include urea, ethylene urea, acetoacetamide, or mixtures thereof. Suitable sulfur-based formaldehyde scavengers may include alkali and/or alkali earth metal dithionites, pyrosulfites, sulfites, bisulfites, metasulfites, monoalkyl sulphites, dialkyl sulphites, dialkylene sulphites, sulfides, thiosulfates, thiocyanates, mercaptans, thiourea, and mixtures thereof.

### Treatment Adjuncts

The liquid conditioning compositions of the present disclosure may include other treatment adjunct ingredients. The adjunct ingredients may be selected to provide, for example, processing, stability, and/or performance benefits.

Suitable treatment adjuncts may include surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, structurants, anti-agglomeration agents, coatings, formaldehyde scavengers, and/or pigments.

In particular, the liquid conditioning composition may further comprise a treatment adjunct selected from the group consisting of: additional conditioning agents, dyes, pH control agents, solvents, rheology modifiers, structurants, cationic polymers, surfactants, perfume, perfume delivery systems, chelants, antioxidants, preservatives, or mixtures thereof.

The precise nature of these additional components, and levels of incorporation thereof, will depend on the physical form of the composition and the nature of the operation for which the resulting composition is to be used. However, when one or more adjuncts are present, such one or more adjuncts may be present as detailed below. The following is a non-limiting list of adjunct ingredients that may be useful.

### 1. Rheology Modifier/Structurant

The liquid conditioning compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as perfume encapsulates as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C₁-C₃₀ alkyl ester of the (meth)acrylic acid. Such copolymers are available from Noveon Inc. under the tradename Carbopol Aqua 30. Another suitable structurant is sold under the tradename Flosoft FS 222 available from SNF Floerger.

### 2. Cationic Polymer

The liquid conditioning compositions of the present disclosure may comprise a cationic polymer. Cationic polymers may serve as deposition aids, e.g., facilitating improved deposition efficiency of softening and/or freshness actives onto a target surface. Additionally, or alternatively, cationic polymers may provide stability, structuring, and/or rheology benefits to the composition.

The liquid conditioning compositions may comprise, by weight of the composition, from 0.0001% to 3%, preferably from 0.0005% to 2%, more preferably from 0.001% to 1%, or from about 0.01% to about 0.5%, or from about 0.05% to about 0.3%, of a cationic polymer.

Cationic polymers in general and their methods of manufacture are known in the literature. Suitable cationic polymers may include quaternary ammonium polymers known the “Polyquaternium” polymers, as designated by the International Nomenclature for Cosmetic Ingredients, such as Polyquaternium-6 (poly(diallyldimethylammonium chloride), Polyquaternium-7 (copolymer of acrylamide and diallyldimethylammonium chloride), Polyquaternium-10 (quaternized hydroxyethyl cellulose), Polyquaternium-22 (copolymer of acrylic acid and diallyldimethylammonium chloride), and the like.

The cationic polymer may comprise a cationic polysaccharide, such as cationic starch, cationic cellulose, cationic guar, or mixtures thereof. The cationic cellulose may comprise a quaternized hydroxyethyl cellulose. Polymers derived from polysaccharides may be preferred, being naturally derived and/or sustainable materials.

The cationic polymer may comprise a cationic acrylate. The cationic polymer may comprise cationic monomers, nonionic monomers, and optionally anionic monomers (so long as the overall charge of the polymer is still cationic. The cationic polymer may comprise cationic monomers selected from the group consisting of methyl chloride quaternized dimethyl aminoethylammonium acrylate, methyl chloride quaternized dimethyl aminoethylammonium methacrylate and mixtures thereof. The cationic polymer may comprise nonionic monomers selected from the group consisting of acrylamide, dimethyl acrylamide and mixtures thereof. The cationic polymer may optionally comprise anionic monomers selected from acrylic acid, methacrylic acid, itaconic acid, crotonic acid, maleic acid, fumaric acid, as well as monomers performing a sulfonic acid or phosphonic acid functions, such as 2-acrylamido-2-methyl propane sulfonic acid (ATBS), and their salts.

The cationic polymer may substantially linear or may be cross-linked. The composition may comprise both a substantially linear cationic polymer (e.g., formed with less than 50 ppm cross-linking agent) and a cross-linked cationic polymer (e.g., formed with greater than 50 ppm cross-linking agent). Such combinations may provide both deposition and structuring benefits.

### 3. Surfactant

The liquid conditioning compositions may include less than 5%, or less than 2%, or less than 1%, or less than about 0.1%, by weight of the composition, of anionic surfactant, or even be substantially free of anionic surfactant. Anionic surfactants can negatively impact the stability and/or performance of the present compositions, as they may undesirably interact with cationic components such as the conditioning compounds. Product compositions intended to be added during the rinse cycle of an automatic washing machine, such as a liquid fabric enhancer, may include relatively low levels of anionic surfactant. Additionally or alternatively, compositions intended to be used in combination with a detergent composition during the wash cycle of an automatic washing machine may include relatively low levels of anionic surfactant.

The liquid conditioning compositions may comprise nonionic surfactant. Such surfactants may provide, for example, stability and/or processing benefits. The nonionic surfactants may be emulsifiers, for example, of perfume. The nonionic surfactants may be alkoxylated fatty alcohols, such as ethoxylated C10-C18 fatty alcohols.

### 4. Chelant

The liquid conditioning compositions may comprise a chelant (aka, chelating agent). Such agents may be iron and/or manganese and/or other metal ion chelating agents. Such chelating agents can be selected from the group consisting of amino carboxylates, amino phosphonates, polyfunctionally-substituted aromatic chelating agents, and mixtures therein. If utilized, these chelating agents will generally comprise from about 0.1% to about 15%, preferably from about 0.1% to about 3.0%, by weight of the compositions described herein. More preferably, if utilized, the chelating agents will comprise from about 0.1% to about 3.0% by weight of such compositions.

Suitable chelants may include: diethylenetriaminepentaacetic acid (DTPA); hydroxyethanedimethylenephosphonic acid (HEDP); MGDA(methylglycinediacetic acid); glutamic acid, N,N-diacetic acid (GLDA); 1,2-dihydroxybenzene-3,5-disulfonic acid (Tiron™); ethylenediamine disuccinate (EDDS); diethylenetriamine penta (methylene phosphonic acid) (DTPMP); ethylenediaminetetrakis(methylenephosphonates); ethylenediaminetetracetates; N-(hydroxyethyl)ethylenediaminetriacetates; nitrilotriacetates; ethylenediamine tetraproprionates; triethylenetetraaminehexacetates; diethylenetriamine-pentaacetates; ethanoldiglycines; alkali metal, ammonium, or substituted ammonium salts thereof; dihydroxydisulfobenzenes such as 1,2-dihydroxy-3,5-disulfobenzene; and mixtures thereof.

### 5. Antioxidants

The liquid conditioning compositions may comprise an antioxidant, preferably a phenolic antioxidant, more preferably a tocopherol antioxidant or a derivative thereof. Antioxidants in the presently disclosed composition may be useful for malodor control, cleaning performance, and/or color stability, as they may help to reduce yellowing that may be associated with amines. Furthermore, and without wishing to be bound by theory, it is believed that the presence of an antioxidant will reduce the rate of auto-oxidation of the trans-unsaturated bonds of the ester quat fatty acid chains and may therefore contribute to viscosity stability of the compositions. Antioxidants are substances as described in Kirk-Othmer (Vol. 3, page 424) and in Ullmann's Encyclopedia (Vol. 3, page 91).

The compositions of the present disclosure may include an antioxidant, preferably a phenolic antioxidant, even more preferably a tocopherol or a derivative thereof, in an amount of from about 0.001% to about 2%, preferably from about 0.01% to about 0.5%, by weight of the composition.

A specifically preferred class of antioxidants for use in the compositions of the present disclosure are tocopherols and derivatives thereof, such as tocotrienols. Such antioxidants are typically naturally derived and therefore may be of particular interest to be coupled with an ester quat material for sustainability/environmental reasons. Furthermore, such compounds may be viewed by the consumer as familiar, beneficial, and safe due to the vitamin E activity of the compounds. Tocopherols useful in the present compositions may include alpha-tocopherol, beta-tocopherol, gamma-tocopherol, delta-tocopherol, or combinations thereof.

Other suitable antioxidants may include other phenolic antioxidants, such as butylated hydroxytoluene (“BHT”; specifically, 3,5-di-tert-butyl-4-hydroxytoluene) and butylated hdroxyanisol (“BHA”). Still other suitable antioxidants may include Proxel GXL™, Trolox™, Raluquin™, and/or those sold under the TINOGARD® tradename.

### 6. Preservative

The liquid conditioning composition may comprise a preservative, which can help with product stability upon storage. The preservative may comprise a diphenyl ether antimicrobial agent, preferably 4-4′-dichloro-2-hydroxydiphenyl ether, 2,4,4′-trichloro-2′-hydroxydiphenyl ether, sodium benzoate, or combinations thereof. The preservative may comprise a quaternary ammonium antimicrobial agent, preferably dialkyl quaternary ammonium antimicrobial agents. Suitable preservative may include those sold under the TINOSAN and/or BARQUAT tradenames.

### 7. Additional Conditioning Agents

The liquid conditioning compositions of the present disclosure may comprise other conditioning agents in addition to the ester quats described above. The additional conditioning agents may be selected from the group consisting of quaternary ammonium ester compounds other than those described above, silicones, non-ester quaternary ammonium compounds, amines, fatty esters, sucrose esters, silicones, dispersible polyolefins, polysaccharides, fatty acids, softening or conditioning oils, polymer latexes, glyceride copolymers, polyoils, or combinations thereof.

The composition may include a combination of a quaternary ammonium ester compound and a silicone. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1. When determining amounts of quaternary ammonium ester compounds as described in this paragraph, the amount may refer to ester quats as described in the previous section, or the total amount of ester quats as described above, plus any additional quaternary ammonium ester compounds that may be present.

### Softening Beads or Granules

The softening beads or granules can each have a mass from about 1 mg to about 1 gram, alternatively from about 2 mg to about 500 mg, alternatively from about 5 mg to about 500 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg or a mixture of the foregoing. The plurality of particles within a package can comprise less than 10% by weight of particles having an individual mass less than about 10 mg. This can reduce the potential for dust.

An individual particle may have a volume from about 0.003 cm³ to about 5 cm³, optionally from about 0.003 cm³ to about 1 cm³, optionally from about 0.003 cm³ to about 0.5 cm³, optionally from about 0.003 cm³ to about 0.2 cm³, optionally from about 0.003 cm³ to about 0.15 cm³. Smaller particles are thought to provide better packing of the particles in a container and faster dissolution in the wash. It may be desirable to vary the volume of the particles within a package to create variable dissolution profiles.

The softening beads or granules may have any shape selected from the group consisting of spherical, hemispherical, compressed hemispherical, cylindrical, disc, circular, lentil-shaped, oblong, cubical, rectangular, star-shaped, flower-shaped, discorectangle and any combinations thereof. Lentil-shaped refers to the shape of a lentil bean. Preferably, the particles of the present disclosure have a hemispherical or compressed hemispherical shape.

The softening beads or granules may each have a maximum dimension of from about 2 mm to 10 mm, preferably from about 3 mm to about 9 mm, more preferably from about 4 mm to about 8 mm. the particle may have a substantially flat base and a height measured orthogonal to said base and together said particles have a distribution of heights, wherein said distribution of heights has a mean height between about 1 mm and about 5 mm and a height standard deviation less than about 0.3. The particles disclosed herein can have ratio of maximum dimension to minimum dimension from about 10 to 1, optionally from about 8 to 1, optionally about 5 to 1, optionally about 3 to 1, optionally about 2 to 1. The particles disclosed herein can be shaped such that the particles are not flakes.

It is worth noting that preferably each of the softening beads comprises at least one flat surface. The flat surface of each of the particles can correspond to an interface between the particle (during formation) and the belt upon which the particles are formed. Preferably the flat surface has a maximum dimension that is no less than 33 percent of the height of the particle, even more preferably no less than 40 percent of the height, or most preferably no less than 50 percent of the height of the particle, or most preferably no less than 70 percent of the height of the particle. A larger flat base for each of the particles can facilitate processing as the particles are less likely to roll off of the belt during process.

The softening beads or granules can comprise about 25% to 99% by weight water-soluble carrier and a softening agent dispersed in the water-soluble carrier. The particles can be provided with from about 5% to about 45% by weight of the composition of softening active. The softening active may preferably comprise a quaternary ammonium ester compound.

The softening beads or granules can comprise less than about 20% by weight anionic surfactant, optionally less than about 10% by weight anionic surfactant, optionally less than about 5% by weight anionic surfactant, optionally less than about 3% by weight anionic surfactant, optionally less than about 1% by weight anionic surfactant. The particles can comprise from 0 to about 20%, optionally from 0 to about 10%, optionally from about 0 to about 5%, optionally from about 0 to about 3%, optionally from about 0 to about 1% by weight anionic surfactant. In some configurations, the particles of the present disclosure may be substantially free of anionic surfactant.

The softening beads or granules can comprise less than about 10% by weight water.

### Water-Soluble Carrier

The softening beads or granules may comprise 25% to 99% by weight of a water-soluble carrier. While any suitable material may be utilized as the water-soluble carrier, one preferred composition comprises polyalkylene glycol.

Polyalkylene glycol water-soluble carrier can be materials selected from polyethylene glycol, polypropylene glycol, ethylene oxide/propylene oxide block copolymers, and combinations thereof. For example, the water-soluble carrier can be polyethylene glycol (PEG). PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

The softening beads or granules can comprise about 25% to about 99% by weight of the particles of PEG. Optionally, the particles can comprise from about 35% to about 99%, optionally from about 40% to about 99%, optionally from about 50% to about 99%, optionally combinations thereof and any whole percentages or ranges of whole percentages within any of the aforementioned ranges, of PEG by weight of the respective particles. Preferably, the PEG present in the particles is characterized by a weight average molecular weight (Mw) ranging from about 2,000 to about 20,000 Daltons, optionally from about 2000 to about 15000 Da, alternatively from about 4000 to about 20000 Da, alternatively from about 4000 to about 15000 Da, alternatively from about 4000 to about 12000 Da, alternatively from about 5000 to about 11000 Da, alternatively from about 6000 to about 10000 Da, alternatively from about 7000 to about 9000 Da, alternatively combinations thereof. Suitable PEGs include homopolymers commercially available from BASF under the tradenames of Pluriol® E 8000.

While combinations of molecular weight PEG may be utilized, it is believed that PEG have a molecular weight below 4000 Da, should have a relatively low level of weight percentage use as compared to the PEG having a molecular weight above that of 4000 Da. It is believed that PEG having a molecular weight below 4000 Da, has a lower melt temperature and can introduce processing difficulties. To offset this lower melt temperature of the lower molecular weight PEG, higher molecular weight PEG may be utilized at a higher weight percentage than that of the lower molecular weight PEG. For example, the higher molecular weight PEG may be introduced at a ratio of at least about 1.1:1. It is worth noting that the lower the molecular weight of a first PEG constituent, the higher the molecular weight of the second PEG constituent may be needed in order to alleviate the processing difficulties. Or, in such configurations, a higher ratio of weight percentage of the second PEG constituent may be needed, e.g., at least about 1.3:1.

Alternatively, the polyalkylene glycol water-soluble carrier can be an ethylene oxide-propylene oxide-ethylene oxide (EOx₁POyEOx₂)triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOx₁POyEOx₂)triblock copolymer has a molecular weight of from about 2000 to about 30,000 Daltons, preferably from about 3000 to about 20,000 Daltons, more preferably from about 4000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂)triblock copolymer improve cleaning.

Suitable ethylene oxide—propylene oxide—ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

The polyalkylene glycol water-soluble carrier also included “end capped” polyalkylene glycol. Typically, polyalkylene glycol has two —OH groups at both ends of the polymer chain, “end capped” means at least one or both of the —OH groups are reacted and connected to end capping organic group different from the polyalkylene glycol. Preferably, the end capping organic group R connected to the —OH groups of the polyalkylene glycol via an ether bond (—O—R) and/or ester bond (—O—(C═O)—R), where R is a linear or branched C₁-C₃₀ alkyl group, a cycloalkyl group with 5 to 9 carbon atoms, a C₆-C₃₀ arylalkyl group, a C₆-C₃₀ alkylaryl group. More preferably, R is a linear or branched C₁-C₃₀ alkyl group, even more preferably a linear C₁-C₆ alkyl group and even more preferably a methyl (CH₃).

Examples of suitable “end capped” polyalkylene glycol include a polyethylene glycol fatty alcohol ether of formula:

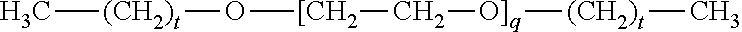

wherein
q is based on a molar average, a number from 30 to 250.
t is based on a molar average, a number from 0 to 30.

Examples of suitable “end capped” polyalkylene glycol include a polyethylene glycol fatty alcohol esters of formula:

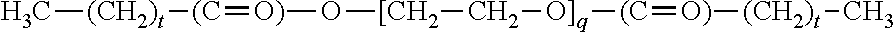

wherein
q is based on a molar average, a number from 30 to 250.
t is based on a molar average, a number from 0 to 30.

Additional options for polyalkylene glycol include modified polyalkylene glycol having a formula of:

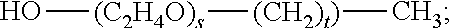

wherein
s is based on a molar average, a number from 63-68
t is based on a molar average, a number from 13 to 19, preferably 17.

Carrier compositions comprising the above formulation may comprise from about 10 wt. % to about 60 wt. % of the above modified polyalkylene glycol, preferably from about 20 wt. % to about 50 wt. %, even more preferably from about 25 wt. % to about 45 wt. %, and most preferably from about 30 wt. % to about 40 wt. %.

### Other Water-Soluble Carriers

The water-soluble carrier can be a material that is soluble in a wash liquor within a short period of time, for instance less than about 10 minutes.

The particle may further comprise other water-soluble carriers selected from inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, and combinations thereof.

Suitable inorganic alkali metal salts can be selected from the group consisting of sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium silicate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium silicate, and combinations thereof.

Suitable inorganic alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium silicate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium silicate, and combinations thereof.

Organic salts, such as organic alkali metal salts and organic alkaline earth metal salts, contain carbon.

Suitable organic alkali metal salts can be selected from the group consisting of sodium acetate, sodium citrate, sodium lactate, sodium tartrate, sodium ascorbate, sodium sorbate, potassium acetate, potassium citrate, potassium lactate, potassium tartrate, potassium ascorbate, potassium sorbate, and combinations thereof.

Suitable organic alkali metal salts can be selected from the group consisting of calcium acetate, calcium citrate, calcium lactate, calcium tartrate, calcium ascorbate, calcium sorbate, magnesium acetate, magnesium citrate, magnesium lactate, magnesium tartrate, magnesium ascorbate, magnesium sorbate, and combinations thereof.

Carbohydrates may be selected from the group consisting of monosaccharides, disaccharides, oligosaccharides, polysaccharides and derivatives thereof, and combinations thereof.

Suitable monosaccharides may be selected from the group consisting of erythrose, ribose, arabinose, xylose, glucose, isoglucose, dextrose, galactose, mannose, erythrulose, ribulose, fructose, sorbose, rhamnose, fucose, deoxyribose, ribose, and combinations thereof.

Suitable disaccharides sugar may be selected from the group consisting of sucrose, maltose, lactose, isomaltose, trehalose, cellobiose, melibiose, gentiobiose, and combinations thereof.

Suitable oligosaccharides may be selected from the group consisting of maltotriose, raffinose, stachyose, and combinations thereof.

Preferably the sugar is selected from the group consisting of fructose, glucose, isoglucose, galactose, raffinose, and combinations thereof. More preferably the sugar comprises or is sucrose.

Suitable polysaccharides may be selected from the group consisting of homopolysaccharides, heteropolysaccharides, and combinations thereof.

Suitable polysaccharides may be selected from the group consisting of starch, corn starch, wheat starch, rice starch, potato starch, tapioca starch, modified starch, cellulose, carboxymethyl cellulose, methyl cellulose, ethyl cellulose, propyl cellulose, hydroxyethyl cellulose, hydroxypropyl cellulose, cellulose esters, cellulose amides, glycogen, pectin, dextrin, maltodextrin, corn syrup solids, alginates, xyloglucans, xylan, glucuronoxylan, arabinoxylan, mannan, dextran, glucomannan, galactoglucan, xanthan, carrageenan, locust bean gum, Arabic gum, tragacanth, and combinations thereof.

Carbohydrate derivatives may be selected from the group consisting of amino sugars, deoxysugars, sugar alcohols, sugar acids, and combinations thereof.

Suitable sugar alcohol may be selected from the group consisting of sorbitol, mannitol, isomalt, maltitol, lactitol, xylitol, erythritol, and combinations thereof. Preferably the sugar alcohol is selected from the group consisting of mannitol, sorbitol, xylitol and combinations thereof. Sugar alcohol polyols are described in additional detail in U.S. Pat. No. 11,920,111.

The water-soluble carrier may be selected from the group consisting of clay, zeolites, silica, silicates, citric acid and salts thereof, fatty alcohol, glyceryl diester of hydrogenated tallow, and combinations thereof.

The water-soluble carrier may be a water-soluble polymer selected from the group consisting of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyglycerol esters, acrylamide; polyvinyl acetates; polycarboxylic acids and salts thereof, sulfonated polyacrylates, polyaminoacids or peptides, polyamides, polyacrylamide, copolymers of maleic/acrylic acids, gelatin, and combinations thereof.

Some specific examples of suitable carrier materials can include combinations of the foregoing. For example, a carrier material may comprise a mixture of a first wt. % of polyethylene glycol; a second wt. % of sodium bicarbonate; a third wt. % of sodium acetate trihydrate. In such configurations, the first wt. % may be from about 30 to about 70, more preferably from about 40 to about 60, even more preferably from about 45 to about 58, or most preferably from about 52 to about 56.

The second wt. % may be from about 10 to about 30, more preferably from about 15 to about 25, even more preferably from about 15 to about 20. It is worth noting that where higher percentages of sodium bicarbonate are utilized, dissolution problems can occur. For example, where hard water is utilized as part of the wash process, it is believed that a portion of the sodium carbonate may react with the hard water and form calcium carbonate. As the calcium carbonate may not dissolve entirely in the wash process, pieces of calcium carbonate may appear on clothes which can give consumers a negative impression of the performance of the particle.

The third wt. % may be from about 10 to about 30, more preferably from about 15 to about 25, even more preferably from about 15 to about 20. It is worth noting that where higher percentages of sodium acetate are utilized, discoloring as well as generation of odor can occur. It is believed that the sodium acetate can degrade and form acetic acid. The acetic acid can cause discoloration of the particles as well as a vinegary smell for the particles. This can cause consumers to have a very negative impression of the performance of the particles, particularly where the particles are advertised to provide a great smelling fragrance to articles of laundry.

As another example, the carrier material may comprise polyethylene glycol, block copolymer of ethylene oxide and propylene oxide and clay, e.g. bentonite and/or other organic clay materials.

As another example, the carrier material may comprise sodium chloride, propylene glycol, and sodium starch octenylsuccinate.

As another example, the carrier material may comprise sodium acetate, dipropylene glycol, cellulose, sodium hydroxide, and sodium acrylate copolymer.

As yet another example, the carrier material may comprise a modified polyethylene glycol as described herein along with polyethylene glycol. The modified polyethylene glycol may have a higher molecular weight than the polyethylene glycol. Additionally, the modified polyethylene glycol may be present at a higher weight percentage than the polyethylene glycol.

As yet another example, the carrier material may comprise from about 45% to about 80%, preferably about 50% to about 70%, preferably about 50% to about 60%, by weight sugar alcohol polyol selected from the group consisting of or selected from or selected from at least one of erythritol, xylitol, mannitol, isomalt, maltitol, lactitol, trehalose, lactose, tagatose, sucralose, and mixtures thereof.

### Esterquat Softening Active

The softening beads or granules comprise a softening active, preferably a quaternary ammonium compound so that the particles can provide a softening benefit to laundered fabrics through the wash, and in particular during the wash sub-cycle of a washer having wash and rinse sub-cycles. The quaternary ammonium compound (quat) can be an ester quaternary ammonium compound. Suitable quaternary ammonium compounds include but are not limited to, materials selected from the group consisting of ester quats, amide quats, imidazoline quats, alkyl quats, amidoester quats and combinations thereof. Suitable ester quats include but are not limited to, materials selected from the group consisting of monoester quats, diester quats, triester quats and combinations thereof. The details of suitable ester quats for the softening beads and/or granules are the same as those detailed in the “Esterquat Softening Active” section under the “Liquid Fabric Conditioning Compositions” section contained herein.

The softening beads or granules comprise 5% to 45% by weight a quaternary ammonium compound. The quaternary ammonium compound has an Iodine Value from 18 to 60, optionally 18 to 56, optionally 20 to 60, optionally 20 to 56, optionally 20 to 42, and any whole numbers within the aforesaid ranges. Optionally the softening beads or granules can comprise 10% to 40% by weight a quaternary ammonium compound, further optionally having any of the aforesaid ranges of Iodine Value. Optionally the softening beads or granules can comprise 20% to 40% by weight a quaternary ammonium compound, further optionally having the aforesaid ranges of Iodine Value.

### Process of Making the Laundry Compositions

The laundry compositions detailed herein (either detergent compositions or fabric conditioning compositions) can be made using any suitable process known to the skilled person. Typically, the ingredients are blended together in any suitable order. Preferably, any detersive surfactants are added as part of a concentrated premix, to which are added the other optional ingredients. Preferably, any solvent is added either last, or if an external structurant is added, immediately before the external structurant, with the external structurant being added as the last ingredient.

### Regimen or Array of Laundry Compositions

The methods of laundering fabric detailed herein may utilize a combination of two or more laundry compositions such as a detergent composition as described herein and a fabric conditioning composition as described herein that may take the form of a liquid fabric softener, a fabric softening bead, a fabric softening sheet, or a fabric softening bar, etc. Such a regimen or array of products produce better results in an overall laundering process than randomly bought detergent compositions and fabric conditioning compositions. The detergent compositions and the fabric conditioning compositions detailed herein are meant to be used together in a single laundering process to yield optimal results for the consumer (better cleaning and/or better softness of fabrics, as compared to a process u. These products may be produced and marketed in an array or regimen. For instance, the detergent composition and the fabric conditioning composition may be identified and/or marketed under the same or similar brand name. Having the same or similar brand name may indicate to a consumer that these separate products should be used in a single laundering process for better results. Alternatively, the detergent composition and the fabric softening composition may be produced to include the same, or complimentary, perfume(s) as to give the consumer the same, or complimentary, scents during the laundering process. Having the same scent name may indicate to a consumer that these separate products should be used in a single laundering process for better results. Alternatively, the detergent composition and the fabric softening composition may be produced to be the same unique color. Having the same color may indicate to a consumer that these separate products should be used in a single laundering process for better results. Further, the compositions useful for the methods of laundering detailed herein may be sold in a single package, or in another sales method that connects the products in consumer's mind (coupon for a discount when you buy both products). Further, the compositions useful for the methods of laundering detailed herein may be advertised on the packaging of the compositions that suggest or recommends using the products together in a laundering process.

### Combinations

Specifically contemplated combinations of the disclosure are herein described in the following lettered paragraphs. These combinations are intended to be illustrative in nature and are not intended to be limiting.
A. A method of laundering fabric, the method comprising the steps of washing a fabric in at least one wash step, wherein in the at least one wash step, the fabric is washed with a detergent composition that comprises i. from about 1% to about 30%, by weight of the composition of a branched alkyl sulfate anionic surfactant consisting essentially of a mixture of surfactant isomers of Formula 1 and surfactants of Formula 2:

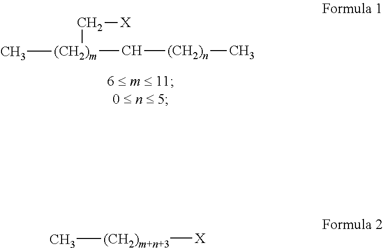

wherein from about 50% to about 100% by weight of the branched alkyl sulfate anionic surfactant are isomers having m+n=11; wherein between about 25% to about 50% of the mixture of surfactant isomers of Formula 1 have n=0; wherein from about 0.001% to about 25% by weight of the branched alkyl sulfate anionic surfactant are surfactants of Formula 2; and wherein X is a hydrophilic moiety; and a softening the fabric in at least one treatment step, wherein in the at least one treatment step, the fabric is softened with a fabric conditioning composition comprising alkyl quaternary ammonium ester material.
B. The method according to Paragraph A, wherein the detergent composition further comprises a secondary surfactant wherein the secondary surfactant is an anionic surfactant, a nonionic surfactant an amphoteric surfactant or combinations thereof.
C. The method according to any of Paragraphs A-B, wherein the ratio by weight of the branched alkyl sulfate anionic surfactant to the secondary surfactant is from about 2:1 to about 1:2.
D. The method according to any of Paragraphs A-C, wherein the ratio by weight of the branched alkyl sulfate anionic surfactant to the secondary surfactant is about 1:1.
E. The method according to any of Paragraphs A-D, wherein the detergent composition further comprises a tertiary surfactant comprising an additional nonionic surfactant, an anionic surfactant, an additional amphoteric surfactant or a combination thereof.
F. The method according to any of Paragraphs A-E, wherein the tertiary surfactant comprises a combination of alkyl ethoxy sulfate and a nonionic surfactant.
G. The method according to any of Paragraphs A-F, wherein the tertiary surfactant comprises an anionic surfactant and a nonionic surfactant comprising an ethoxylated alcohol.
H. The method according to Paragraph A-G, wherein the detergent composition further comprises an enzyme, an enzyme stabilizer, a builder, a hueing agent, anti-soil redeposition agent, a bleach, or a combination thereof.
I. The method according to Paragraph A-H, wherein the fabric conditioning composition comprises from about 3% to about 20%, or more preferably about 3% to about 15%, by weight of the composition, of the alkyl ester quaternary ammonium ester material.
J. The method according to any of Paragraphs A-I, wherein the alkyl ester quaternary ammonium ester material is selected from a group consisting of KRA, BFA, hard tallow, soft tallow, and mixtures thereof.
K. The method according to any of Paragraphs A-J, wherein the conditioning composition further comprises a deposition polymer selected from a group consisting of CDB, LS660, and mixture thereof.
L. The method according to any of Paragraphs A-K, wherein the conditioning composition is in a product form selected from a group consisting of liquid fabric enhancer, beads, fabric enhancer sheets, and mixtures thereof.
M. A method of providing improved softness to a fabric, the method comprising the steps of treating a fabric in a rinse liquor that comprises water, alkyl quaternary ammonium ester material, and a branched alkyl sulfate anionic surfactant that is a mixture of surfactant isomers of Formula 1 and surfactants of Formula 2:

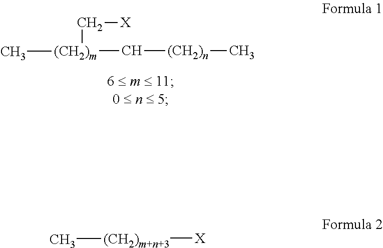

wherein X is a hydrophilic moiety.
N. The method according to Paragraph M, wherein the rinse liquor has a branched alkyl sulfate anionic surfactant concentration of from about 5 ppm to about 200.
O. The method according to Paragraphs M-N, wherein the rinse liquor has an alkyl quaternary ammonium ester concentration of about 1 ppm to about 2000 ppm.
P. The method according to Paragraphs M-O, wherein the fabric is selected from the group consisting of: cotton, polyester, and mixtures thereof, preferably wherein the fabric comprises cotton.
Q. The method according to Paragraphs M-P, wherein the rinse liquor further comprises perfume encapsulates.
R. The method according to Paragraphs M-Q, wherein the rinse liquor further comprises a treatment adjunct selected from the group consisting of: additional conditioning agents, dyes, pH control agents, solvents, rheology modifiers, structurants, cationic polymers, surfactants, perfume, perfume delivery systems, chelants, antioxidants, preservatives, or mixtures thereof.
S. A method of laundering fabric in an automated washing machine, the method comprising the steps of placing a fabric in a drum of the automated washing machine, dispensing water and a detergent composition into the drum to create a wash liquor, wherein the fabric in washed in the wash liquor in at least one wash step, the detergent composition comprising: i. from about 1% to about 30%, by weight of the composition of a branched alkyl sulfate anionic surfactant consisting essentially of a mixture of surfactant isomers of Formula 1 and surfactants of Formula 2:

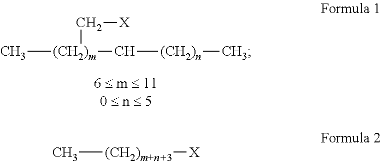

wherein from about 50% to about 100% by weight of the branched alkyl sulfate anionic surfactant are isomers having m+n=11; wherein between about 25% to about 50% of the mixture of surfactant isomers of Formula 1 have n=0; wherein from about 0.001% to about 25% by weight of the branched alkyl sulfate anionic surfactant are surfactants of Formula 2; and wherein X is a hydrophilic moiety; and draining the wash liquor from the drum; and dispensing water and a fabric conditioning composition into the drum to create a treatment liquor, wherein the fabric is softened in at least one treatment step, the fabric conditioning composition comprising an alkyl quaternary ammonium ester material.
T. The method according to Paragraph S, wherein the detergent composition further comprises a secondary surfactant comprising linear alkyl benzene sulfonate.

### Test Methods

### Softness Evaluation Method-Instron

The method involves the use of an Instron instrument assessment of flat, 100% cotton, woven fabrics (technical fabric 479 from TESTFABRICS, Inc.). Details of the equipment used are listed in Table A below.

| Equipment | Specification |
|---|---|
| Instron Model 5944 Materials Testing System | Capacity 2 kN (200 kg, 450 lb) |
| Static load cell | 500N (50 kg, 112 lb) - Type Of |
| Pneumatic Side Action Grips | Capacit 250N (50 lbf, 25 kgf) |
| Grip Jaw Faces | Faces, Serrated, 25 mm wide × 25 mm high |
| | (1 × 1 in) |
| Bluehill Universal Testing Software | Materials and components testing software |
| | package |
| Textiles Application Module | Software module for Bluehill software |
| Compressed air supply line | Regulated air supply providing at least down |
| | to 60 psi |

Fabric swatches are cut into 4.5″×1″ (114.3 mm×25.4 mm) strips prior to evaluation via the Instron but after they have been treated via the fabric preparation method. This is done by cutting the edge of one entire side of the 479 fabric swatch in the warp direction and carefully peeling off the strings without stressing the fabric until an even edge is achieved. The fabric strips are cut 4.5″ lengthwise in the warp direction and 1″ wide in the weft direction. A total of 3 strips are cut from each swatch. Each external replicate contains 3, 479 fabric swatches, resulting in a total of 9 internal replicates (3 strips from each 479 swatch in the fabric bundle). The strips of fabrics are then equilibrated in a 20° C. and 50% relative humidity for at least 16 hrs before evaluation via the Instron instrument.

The Instron is set up by attaching the 500N load cell via details described in the Operator's Guide, page 2-10. Grips are then attached via the details described in the Operator's Guide, page 2-15. The air supply is turned on. The power to the Instron is turned on via the switch on the back of the instrument frame. Allow the Instron to warm up for at least 5 minutes prior to any fabric evaluation. 50% relative humidity for at least 16 hrs before evaluation via the Instron instrument.

The connected computer is turned on and the Bluehill Universal Software is opened. The Instron frame should automatically connect to the software, which will show a “Frame Ready” indicator on the control panel when complete. The load cell is calibrated by ensuring the no sample is loaded, the grips are not touching, and confirming the software has identified the load cell correctly. The Transducer configuration should be set to “Force” and calibration type set to “Automatic”. Select Calibrate on the Bluehill software and okay to confirm when prompted. When the current state of the Instron says “calibrated”, exit the calibration page and go back to the frame menu.

Balance (or zero) the force via the Bluehill software on the screen. Set a 1″ (25.4 mm) gap by using the jog up and jog down buttons on the Instron control panel. Ensure the grips faces are aligned by closing the grips and assessing the overlap. Open the grips and balance (or zero) the force again.

Select the “test” icon and ensure the instrument settings are set to the following: Air Pressure—60 psi, Load Cell—500N, Maximum Strain—10%, Rate of Strain—50 mm/min, Pre-load Force—0.5N (+/−0.15N). Clean grip faces with 70/30 IPA wipes to ensure no residue from previous samples remain on the grip faces.

Using tweezers, place test sample fabric strip in grips by clamping the top of the fabric strip to the top grip and the bottom of the fabric strip to the bottom grip. Ensure the sample is loaded straight and the amount of fabric visible around the grip faces are similar, ensuring no curled edges or overlapping occurs under the grip. Ensure the pre-load force is 0.5N (+/−0.15N). Adjust the fabric strip in the grips with tweezers as needed to ensure the fabric is loaded correctly.

Start the test by selecting the Start arrow in the software. When both arrows on the Instron control panel are lit, release the bottom clamp and re-clamp the sample during the 12 second hold cycle, removing the slack by pre-loading the force 0.5N (+/−0.15N). Repeat this process until 4 hysteresis cycles have been completed for the sample. Remove the sample and repeat until all the replicates of the treatment have been assessed. Once all the strips are finished, select the “Finish Flag” icon, add a name to this set of sample strips, and save. Repeat this process for all fabric strips for all of the treatments, confirming the software has identified the load cell correctly. The Transducer configuration should be set to “Force” and calibration type set to “Automatic”. Select Calibrate on the Bluehill software and okay to confirm when prompted. When the current state of the Instron says “calibrated”, exit the calibration page and go back to the frame menu.

### Softness Evaluation Method-Panel

The method involves the use of an expert qualified sensory descriptive analysis panel to assess fabrics prepared via the wash method to determine the softness of the fabrics. 100% cotton terry towel fabrics were treated with the detergent+fabric softener products as described in the wash test method. The wash test consisted of three wash/rinse cycles, three external replicates and sixteen internal replicates for each test leg (detergent+fabric softener composition). Fabrics from each test leg/external replicate were tumble dried for 45 mins in between each cycle. At the end of the third cycle when the fabrics have completed the tumble dry step, the fabrics are placed in a controlled temperature and humidity room set to 20° C. and 50% humidity for 18 hrs prior to the evaluation by the qualified sensory descriptive analysis panel. The fabrics are removed from the controlled temperature and humidity room on the day of the evaluation by the panel. The panel assessed the softness of the fabric across different attributes including cushion, fluffiness, silkiness, and roughness. Panelists assess the fabrics by manipulating the fabrics in two different ways. One way is by running their fingers on one hand along both sides of the fabric at the same time both in the direction of the fabric loops and against the direction the fabric loops. The other assessment method requires the panelist to fold the fabric in half and lightly squeeze the fabric between their thumb and forefinger. While doing this, the panel provided a score from 0-100 for each replicate with 0 being the least soft and 100 being the most soft. This is done across 16 trained panelists. The outcome reflected the average score across panelists. The higher the score provided by the expert qualified sensory descriptive analysis panel, the softer the fabric is assessed.

### Stain Removal Index Method

The method involves the use of a tergotometer to simulate the washing of fabrics in a washing machine. Test formulations were used to wash the test fabrics together with clean knitted cotton ballast and eleven 6 cm×6 cm SBL2004 soil squares (60 g). SBL2004 sheets were purchased from WFK Testgewebe GmbH and were cut into 6 cm×6 cm squares. The wash tests consisted of two internal and four external replicates for each stain type (Discriminative Sebum, Bacon Grease, Cooked Beef, Grass, Spaghetti Sauce, ASTM Dust Sebum, Tea American Lipton, and APD Blood) and treatments A-D described below (Table 1). The total amount of liquid detergent used in the test was 2.11 grams.

Tergotometer pots containing 1 L of the test wash solution plus test fabrics, soil squares, and ballast at 25° C. and 7 US gpg were agitated at 208 rpm for 12 minutes and spun dry. Fabrics were then rinsed in 15° C. water at 7 US gpg at 167 rpm for 5 minutes and spun dry. After the rinse, fabrics were machine dried on High for 70 minutes before being analysed. Image analysis was used to compare each stain to an unstained fabric control. Software converted images taken into standard colorimetric values and compared these to standards based on the commonly used Macbeth Colour Rendition Chart, assigning each stain a colorimetric value (Stain Level). Eight replicates of each were prepared. Stain removal index scores for each stain can be calculated.

Stain Removal from the Swatches was Measured as Follows:

$$Stain Removal Index ( SRI ) = \frac{Δ {E}_{initial} - Δ {E}_{washed}}{Δ {E}_{initial}} \times 100$$

ΔEᵢₙᵢₜᵢₐₗ=Stain level before washing, calculated from the difference between the standard L*, a* and b* colorimetric measurement of the unwashed stain and unwashed background fabric, while ΔE_{washed}=Stain level after washing, calculated from the difference between the standard L*, a* and b* colorimetric measurement of the washed stain and unwashed background fabric. Technical stain swatches of CW120 cotton containing Discriminative Sebum (PCS132), Dyed Bacon Grease (GSRTBGD001), Cooked Beef (GSRTCB001), Grass (GSRTGR001), Spaghetti Sauce Ragu (GSRTSS002), ASTM Dust Sebum (PCS94), Tea American Lipton (GSRTLIT001), and APD Blood can be purchased from Accurate Product Development (Fairfield, OH).

### Coacervate Formation Method

The method involves the creation of a coacervate mixture by mixing the anionic surfactant of interest with the cationic softening active of interest and evaporating water.

Calculations are done to determine the relative weight ratios to create molar ratios of anionic surfactant to cationic softening active, based on raw material purity and molecular weight of the materials of interest. In an appropriately sized container, the calculated amount of anionic surfactant is added for the selected anionic surfactant: cationic softening active molar ratio. Next, the calculated amount of cationic surfactant is added to the container with the anionic surfactant and mixed vigorously via an overhead mixer, stir bar+stir plate, or vortex mixture depending on the size of the sample. Once the mixture is homogenous, it is poured onto a petri dish such that it forms a thin layer of the solution. The petri dish is placed uncovered in an oven at 80° C. for 10 mins to allow water to evaporate. After 10 minutes at 80° C., the petri dish is removed from the oven. Using a spatula or stir rod, the mixture in the petri dish is gently mixed to ensure the mixture is homogenous before any further measurements are taken.

The properties of the coacervate, including rheology, particle size, density, color and/or solubility, can be measured using methods known to the person skilled in the art.

### EXAMPLES

### Detergent Formulation Examples

TABLE 1

| | Inventive | | | |
|---|---|---|---|---|
| | Comp. A | Comparative | Comparative | Comparative |
| | (chassis) | Comp. B | Comp. C | Comp. D |
| Raw Material | % active in formulation | | | |
| NI¹ | 9.88 | 9.88 | 9.88 | 9.88 |
| branched alkyl | 7.75 | — | — | — |
| sulfate² | | | | |
| HLAS³ | 3.62 | 11.38 | 7.50 | 3.62 |
| AES⁴ | 2.22 | 2.22 | 2.22 | 2.22 |
| Sodium lauryl | — | — | 3.88 | 7.75 |
| sulfate⁵ | | | | |
| Amine Oxide⁶ | 0.78 | 0.78 | 0.78 | 0.78 |
| Citric acid⁷ | 0.32 | 0.32 | 0.32 | 0.32 |
| Chelant⁸ | 0.23 | 0.23 | 0.23 | 0.23 |
| Polymer⁹ | 1.37 | 1.37 | 1.37 | 1.37 |
| Protease¹⁰ | 0.08 | 0.08 | 0.08 | 0.08 |
| Misc (water, | Balance | Balance | Balance | Balance |
| stabilizer, | | | | |
| solvent, etc.) | | | | |

¹NOVEL ® 1412-9 from Sasol, Surfonic L24-9 commercially available from Huntsman;
²Branched C15 alkyl sulfate, synthesized as described in Example 1 in US Patent Publication No. 2023/0174894A1 (paragraphs [0099]-[0102];
³High C12 (96%) Linear Alkyl Benzene Sulfonate sourced from P&G Chemicals;
⁴C12-15EO2.5S AlkylethoxySulfate where the alkyl portion of AES has a molecular weight of 211 to 218 daltons, available from P&G Chemicals;
⁵Sodium Lauryl Sulfate sourced from P&G Chemicals;
⁶Amine Oxide sourced from P&G Chemicals;
⁷Citrosol 502 commercially available from Archer Daniels Midland;
⁸Dissolvine ® GL commercially available from Nouryon.;
⁹Lupasol ® commercially available from BASF; and
¹⁰Preferenz Protease from IFF

The comparative and inventive examples are prepared by combining all raw materials to achieve Comparative Composition A-D. The following raw materials were mixed rapidly to achieve a vortex with a mixing impeller for about 60 minutes: water, solvent, surfactant, stabilizer, neutralizer, builder, and chelant to result in a stable one phase liquid.

Before water was added to balance the formulas, caustic or sulfuric was added to achieve a consistent pH of 8.2-8.4 between all tested formulas. Detergent Formulations A-D were then tested using the Stain Removal Index Method as described above, and the Stain Removal Index scores are tabulated below in Table 2.

TABLE 2

| | SRI Inventive | SRI Comparative | SRI Comparative | SRI Comparative |
|---|---|---|---|---|
| Stain Type | Composition A | Composition B | Composition C | Composition D |
| Discriminative Sebum | 29.9 | 29.0 | 28.3 | 30.6 |
| Bacon Grease | 35.9 | 34.6 | 36.2 | 34.4 |
| Cooked Beef | 24.2 | 23.9 | 24.0 | 21.6 |
| Grass | 39.1 | 37.8 | 38.8 | 39.3 |
| Spaghetti Sauce | 76.6 | 76.4 | 75.4 | 75.8 |
| ASTM Dust Sebum | 34.7 | 33.2 | 32.7 | 35.1 |
| Tea American Lipton | 18.5 | 18.0 | 18.3 | 18.8 |
| APD Blood | 85.3 | 84.7 | 84.1 | 85.3 |
| Average | 43.0 | 42.2 | 42.2 | 42.6 |

The cleaning results show when formulating with the inventive composition containing the branched alkyl sulfate as detailed herein, the cleaning result is equal or better vs. the comparative compositions that contain the same level of HLAS, Sodium Lauryl Sulfate or a combination, but without the branched alkyl sulfate as detailed herein.

### Example Laundering Method for Preparing Samples for Softness Testing:

Fabrics were prepared for softness testing and evaluation through a multi-cycle wash test utilizing the four detergent compositions from Table 1 and Fabric Softener Composition A as described in Table 3. Each detergent composition and Fabric Softener Composition A were matched to be used together in a 3-cycle wash of the same fabric bundle. The fabrics were then evaluated via the softness method listed above, providing the results in Table 4 below.

TABLE 3

| | Fabric Softener |
|---|---|
| | Composition A |
| Raw Material | % active in formulation |
| Ester quat¹ | 9.7% |
| Neat Perfume² | 0.41% |
| Perfume Encapsulates³ | 0.47% |
| Deposition Aid⁴ | 0.047% |
| Structuring Polymer⁵ | 0.12% |
| Water and minors (salt, | Balance |
| chelant, etc) | |

¹N,N-bis(hy droxyethyl)-N,N-dimethyl ammonium chloride fatty acid ester, produced from C12-C18 fatty acid mixture (REWOQUAT CI-DEEDMAC, ex Evonik)
²Proprietary blend of perfume raw materials as described above in Neat Perfume, sourced in-house
³Proprietary blend of Encapsulates as described below and supplied by Encapsys (Appleton, Wisconsin): Melamine-formaldehyde perfume capsules (86% core/14% shell): Suitable perfume capsules can be purchased from Encapsys (825 East Wisconsin Ave, Appleton, WI 54911), and are made as follows: 25 grams of butyl acrylate-acrylic acid copolymer emulsifier (Colloid C351, 25% solids, pka 4.5-4.7, (Kemira Chemicals, Inc. Kennesaw, Georgia U.S.A.)) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, New Jersey, U.S.A.)) is added to the emulsifier solution. 200 grams of perfume oil is added to the previous mixture under mechanical agitation and the temperature is raised to 50° C. After mixing at higher speed until a stable emulsion is obtained, the second solution and 4 grams of sodium sulfate salt are added to the emulsion. This second solution contains 7 grams of butyl acrylate-acrylic acid copolymer emulsifier (Colloid C121, 25% solids, Kemira), 120 grams of distilled water, sodium hydroxide solution to adjust pH to 4.8, 25 grams of partially methylated methylol melamine resin (Cymel 385, 80% solids, Cytec). This mixture is heated to 85° C. and maintained overnight with continuous stirring to complete the encapsulation process. 23 grams of acetoacetoamide (Sigma-Aldrich, Saint Louis, Mo USA), 90 grams of a 1% aqueous solution of Optixan Xanthan Gum (ADM Corporation), and 35 grams of 32 wt % magnesium chloride solution (Chemical Ventures) are added. A volume-mean particle size of 18 microns is obtained. Then perfume capsules are coated with a polyvinylformamide deposition aid as follows: 0.6 grams of a cationic modified co-polymer of polyvinylamine and N-vinyl formamide (BASF Corp) are added and mixed overnight. Polyacrylate based capsules encapsulating perfume. Suitable perfume capsules can be purchased from Encapsys, (825 East Wisconsin Aye, Appleton, WI 54911), and are made as follows: a first oil phase, consisting of 37.5 g perfume, 0.2 g tert-butyl amino ethyl methoacrylate, and 0.2 g beta hydroxyethyl acrylate is mixed for about 1 hour before the addition of 18 g CN975 (Sartomer, Exter, PA). The solution is allowed to mix until needed later in the process. A second oil phase consisting of 65 g of the perfume oil, 84 g isopropyl myristate, 1 g 2,2′-azobis(2-methylbutyronitrile), and 0.8 g 4,4′-azobis4-cyanovaleric acid is added to a jacketed steel reactor. The reactor is held at 35° C. and the oil solution in mixed at 500 rpm's with a 2″ flat blade mixer. A nitrogen blanket is applied to the reactor at a rate of 300 cc/mm. The solution is heated to 70° C. in 45 minutes and held at 70° C. for 45 minutes, before cooling to 50° C. in 75 minutes. At 50° C., the first oil phase is added and the combined oils are mixed for 30 another 10 minutes at 50° C.
⁴Cationic polymer Flocare LS660 sourced from SNF Water Science.
⁵RHEOVIS CDX rheology modifier polymer sourced from BASF.

The fabric bundle comprised a fabric composition of 80% cotton and 20% polycotton materials for a total of 6 lb load weight. This load weight includes the test fabrics for softness, which are 100% cotton terry towels, 8″×8″ 479-type fabric swatches, and ballast, which are fabrics not used for testing purposes but balance out the load composition of fabric type and total weight. The ballast is a combination of 100% flat cotton fabrics and 50/50 flat polycotton fabrics to reach the fabric composition and load weight listed above. Traditional top load washing machines set to 12 min wash cycle and 1 rinse cycle were used to launder the fabrics with 60° F. wash and rinse water temperature and water hardness of 7 gpg.

The fabric bundles are each prepared in the same way in separate machines, rotating the machine used between each wash/rinse cycle wherein machines were cleaned with 140° F. hot water between each cycle to avoid cross contamination between samples between cycles. The detergent dose is added to the machine as it is filling with water for the wash cycle. The detergent is added directly to the drum of the washer and dispersed in the water when the water covers the bottom baffles of the center agitator. Once the detergent is added, the fabric bundle is added. The machine is allowed to go through the wash and spin cycle. While the rinse water is being added, the fabric composition is added directly to the drum of the washer and dispersed in the water when the water covers the bottom baffles of the center agitator. Care is taken to avoid pouring the fabric softener composition directly on the fabrics, which remain clinging to the sides of the drum during the rinse water fill. The machine is allowed to go through the rinse and spin cycle. Once the rinse and spin cycle is complete, the fabric bundle is removed and placed into separate electric dryers for 45 mins on high, or until all fabrics are dry. The above process is repeated for a total of three wash/rinse cycles.

After the final electric dryer step after the third wash/rinse cycle, fabrics are placed in a 20° C., 50% relative humidity room for at least 18 hours prior to softness evaluation. The fabrics are evaluated via the softness panel and Instron methods listed above, providing the results in Table 4 below.

TABLE 4

| | Detergent Formulation + Fabric Softener Composition A | | | |
|---|---|---|---|---|
| | A | B | C | D |
| | (Inventive) | (Comparative) | (Comparative) | (Comparative) |
| Panel | 52 | 49 | 45 | 44 |
| Measurement | | | | |
| (higher number | | | | |
| means softer | | | | |
| fabric) | | | | |
| Instron | 220 MPa | 222 MPa | 222 MPa | 224 MPa |
| Measurement | | | | |
| (secant modulus; | | | | |
| lower number | | | | |
| means softer | | | | |
| fabric) | | | | |

The columns of Table 4 list the detergent type employed in the particular leg of the test, and rows represent the type of measurement (either Softness Evaluation Method-Panel or Softness Evaluation Method-Instron, as detailed above). Each of the individual four detergent formulations (A-D) were laundered in combination with Fabric Softener A in the process detailed in Example Laundering Method for Preparing Samples for Softness Testing herein. Higher panel scores indicate softer fabrics based on the expert qualified sensory descriptive analysis panel evaluation on 100% cotton terry towels. Lower secant modulus scores indicate softer fabrics based on Instron evaluation of 479 fabric from TESTFABRICS, Inc. based on the Instron method described above. As evident from the results obtained, a laundering process that utilizes a combination of Inventive Detergent Formulation A and Fabric Softener A softens fabrics better than combinations that use Comparative Detergents B, C, or D and Fabric Softener A.

Further, when a coacervate mixture is created by mixing an anionic surfactant as detailed herein with a cationic softening active as detailed herein and evaporating the water, and then tested for viscosity, it is noted that when the anionic surfactant used has a higher percentage of branching, the resulting coacervate formed has a lower viscosity. Without being bound by theory, this noted “higher branching, lower viscosity” also correlates to the feel of the coacervate on the fabric being softer, thus indicating that the softness performance observed on a fabric is driven by the physical and rheological properties of the coacervate formed. Accordingly, the use of an anionic surfactant with a higher wt % of branching results in a softer, more flowable coacervate which translates to softer feel on fabric.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A method of laundering fabric, the method comprising the steps of:
a. washing a fabric in at least one wash step, wherein in the at least one wash step, the fabric is washed with a detergent composition that comprises:
i. from about 1% to about 30%, by weight of the composition of a branched alkyl sulfate anionic surfactant consisting essentially of a mixture of surfactant isomers of Formula 1 and surfactants of Formula 2: 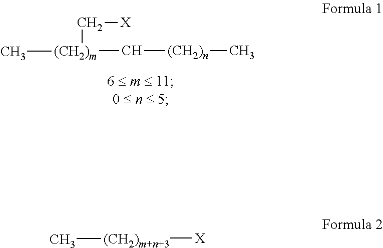
wherein from about 50% to about 100% by weight of the branched alkyl sulfate anionic surfactant are isomers having m+n=11; wherein between about 25% to about 50% of the mixture of surfactant isomers of Formula 1 have n=0; wherein from about 0.001% to about 25% by weight of the branched alkyl sulfate anionic surfactant are surfactants of Formula 2; and wherein X is a hydrophilic moiety; and
b. softening the fabric in at least one treatment step, wherein in the at least one treatment step, the fabric is softened with a fabric conditioning composition comprising alkyl quaternary ammonium ester material.

2. The method according to claim 1, wherein the detergent composition further comprises a secondary surfactant wherein the secondary surfactant is an anionic surfactant, a nonionic surfactant an amphoteric surfactant or combinations thereof.

3. The method according to claim 2, wherein the ratio by weight of the branched alkyl sulfate anionic surfactant to the secondary surfactant is from about 2:1 to about 1:2.

4. The method according to claim 3, wherein the ratio by weight of the branched alkyl sulfate anionic surfactant to the secondary surfactant is about 1:1.

5. The method according to claim 2, wherein the detergent composition further comprises a tertiary surfactant comprising an additional nonionic surfactant, an anionic surfactant, an additional amphoteric surfactant or a combination thereof.

6. The method according to claim 5, wherein the tertiary surfactant comprises a combination of alkyl ethoxy sulfate and a nonionic surfactant.

7. The method according to claim 5, wherein the tertiary surfactant comprises an anionic surfactant and a nonionic surfactant comprising an ethoxylated alcohol.

8. The method according to claim 2, wherein the detergent composition further comprises an enzyme, an enzyme stabilizer, a builder, a hueing agent, anti-soil redeposition agent, a bleach, or a combination thereof.

9. The method according to claim 1, wherein the fabric conditioning composition comprises from about 3% to about 20%, by weight of the composition, of the alkyl ester quaternary ammonium ester material.

10. The method according to claim 1, wherein the alkyl ester quaternary ammonium ester material is selected from a group consisting of KRA, BFA, hard tallow, soft tallow, and mixtures thereof.

11. The method according to claim 1, wherein the at least one wash step and the at least one treatment step occur concurrently.

12. The method according to claim 1, wherein the conditioning composition is in a product form selected from a group consisting of liquid fabric enhancer, beads, fabric enhancer sheets, and mixtures thereof.

13. A method of providing improved softness to a fabric, the method comprising the steps of:
a. treating a fabric in a rinse liquor that comprises water, alkyl quaternary ammonium ester material, and a branched alkyl sulfate anionic surfactant that is a mixture of surfactant isomers of Formula 1 and surfactants of Formula 2: 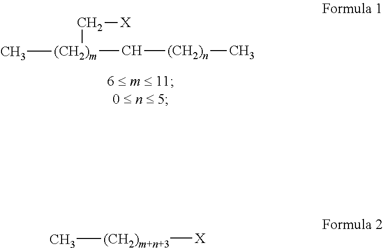
wherein X is a hydrophilic moiety.

14. The method according to claim 13, wherein the rinse liquor has a branched alkyl sulfate anionic surfactant concentration of from about 5 ppm to about 200.

15. The method according to claim 13, wherein the rinse liquor has an alkyl quaternary ammonium ester concentration of about 1 ppm to about 2000 ppm.

16. The method according to claim 13, wherein the fabric is selected from the group consisting of: cotton, polyester, and mixtures thereof, preferably wherein the fabric comprises cotton.

17. The method according to claim 13, wherein the rinse liquor further comprises perfume encapsulates.

18. The method according to claim 13, wherein the rinse liquor further comprises a treatment adjunct selected from the group consisting of: additional conditioning agents, dyes, pH control agents, solvents, rheology modifiers, structurants, cationic polymers, surfactants, perfume, perfume delivery systems, chelants, antioxidants, preservatives, or mixtures thereof.

19. A method of laundering fabric in an automated washing machine, the method comprising the steps of:
a. placing a fabric in a drum of the automated washing machine,
b. dispensing water and a detergent composition into the drum to create a wash liquor, wherein the fabric in washed in the wash liquor in at least one wash step, the detergent composition comprising:
i. from about 1% to about 30%, by weight of the composition of a branched alkyl sulfate anionic surfactant consisting essentially of a mixture of surfactant isomers of Formula 1 and surfactants of Formula 2: 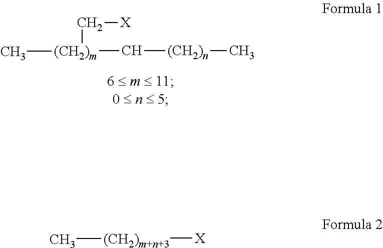
wherein from about 50% to about 100% by weight of the branched alkyl sulfate anionic surfactant are isomers having m+n=11; wherein between about 25% to about 50% of the mixture of surfactant isomers of Formula 1 have n=0; wherein from about 0.001% to about 25% by weight of the branched alkyl sulfate anionic surfactant are surfactants of Formula 2; and wherein X is a hydrophilic moiety; and
c. draining the wash liquor from the drum; and
d. dispensing water and a fabric conditioning composition into the drum to create a treatment liquor, wherein the fabric is softened in at least one treatment step, the fabric conditioning composition comprising an alkyl quaternary ammonium ester material.

20. The method according to claim 19, wherein the detergent composition further comprises a secondary surfactant comprising linear alkyl benzene sulfonate.
